(19) United States
(12) Patent Application Publication
(10) Pub. No.: US 2018/0317397 A1
(43) Pub. Date: Nov. 8, 2018

(54) CUTTING APPARATUS

(71) Applicant: Aerial Tool Corporation, Norval (CA)

(72) Inventor: David Carter, Norval (CA)

(73) Assignee: Aerial Tool Corporation, Norval, ON (CA)

(21) Appl. No.: 15/773,813

(22) PCT Filed: Nov. 29, 2016
(86) PCT No.: PCT/CA2016/051402

§ 371 Date: May 4, 2018

Related U.S. Application Data
(60) Provisional application No. 62/261,733, filed on Dec. 1, 2015.

(51) Int. Cl. A01G 3/08; B25J 15/00; B25J 15/02; B25J 17/02; A01G 23/095; G05B 19/18

(52) U.S. Cl. CPC A01G 3/085; B25J 15/0033; B25J 15/024; B25J 17/0283; G05B 2219/45068; A01G 3/086; A01G 3/088; G05B 19/182; A01G 23/095

(57) ABSTRACT

An apparatus for cutting involves a support configured to stably support the apparatus on a surface, an articulated boom rotatably mounted on the support proximate a first end of the boom, and a hydraulically operated end effector mounted on the boom proximate a second end of the boom. The end effector has a cutter configured to cut an object, and preferably also has an immobilizer (e.g. a gripper) configured to immobilize the object while being cut by the cutter. The end effector has a swivel between the cutter (and/or immobilizer) and the boom, the swivel rotatable continuously through 360° to rotate the cutter (and/or immobilizer) continuously through 360°. The swivel has an internal fluid conduit through which hydraulic fluid may be transported from a hydraulic fluid reservoir to the cutter to hydraulically operate the cutter.

### CROSS-REFERENCE TO RELATED APPLICATIONS

This application claims the benefit of U.S. Provisional Patent Application Ser. No. 62/261,733 filed Dec. 1, 2015, the entire contents of which is herein incorporated by reference.

### FIELD

This application relates to apparatuses for cutting, especially for cutting wood, in particular to robotic tree pruners.

### BACKGROUND

Tree pruning is a dangerous activity often requiring the cutting of branches high in a tree. For individuals, pruning tree limbs high off the ground often requires the use of a ladder and either a hand saw or a chain saw. For utility workers clearing tree limbs from utility lines, cherry pickers are often used in which a basket at the end of a boom is used to transport a worker to the location of the limb being cut. In all of these situations the risk of a tree branch falling on a worker is significant.

To overcome such problems, there have been proposals to use robotic apparatuses in which gripping and cutting elements are attached to an end of a boom, and the boom and the gripping and cutting apparatuses are remotely controlled. U.S. Pat. No. 6,408,906 issued Jun. 25, 2002, the contents of which is herein incorporated by reference, describes one such apparatus. However, such apparatuses still lack some flexibility of operation and have shortcomings in regard to safety. For example, the apparatus described in U.S. Pat. No. 6,408,906 lacks the ability to rotate the gripper continuously through 360° thereby restricting its utility, and is prone to dropping limbs when hydraulic failure occurs, which is a safety hazard.

There remains a need for improved cutting apparatuses, especially for tree pruning.

### SUMMARY

In one aspect, there is provides an apparatus for gripping and cutting, comprising: a support configured to stably support the apparatus on a surface; an articulated boom rotatably mounted on the support proximate a first end of the boom; and, a hydraulically operated end effector mounted on the boom proximate a second end of the boom, the end effector comprising a gripper configured to hold an object to be cut and a cutter configured to cut the object while being held by the gripper, the end effector further comprising a swivel between the gripper and the boom, the swivel rotatable continuously through 360° to rotate the gripper continuously through 360°, the swivel comprising an internal fluid conduit through which hydraulic fluid may be transported from a hydraulic fluid reservoir to the gripper and cutter to hydraulically operate the gripper and cutter.

In another aspect, there is provided an apparatus for cutting, comprising: a support configured to stably support the apparatus on a surface; an articulated boom rotatably mounted on the support proximate a first end of the boom; and, a hydraulically operated end effector mounted on the boom proximate a second end of the boom, the end effector comprising a cutter configured to cut an object, the end effector further comprising a swivel between the cutter and the boom, the swivel rotatable continuously through 360° to rotate the cutter continuously through 360°, the swivel comprising an internal fluid conduit through which hydraulic fluid may be transported from a hydraulic fluid reservoir to the cutter to hydraulically operate the cutter.

The support may comprise anything suitable for supporting the boom. The support may comprise a non-transportable structure (e.g. a concrete pad, steel girders, etc.) or a transportable structure (e.g. a trailer, a truck, a self-propelled mechanical/electrical platform, etc.). The support preferably comprises a transportable structure. The transportable structure may be configured for transporting the apparatus from place to place and/or for localized positioning of the apparatus to facilitate operation of the end effector. The support may further comprise a moveable element to which the boom may be mounted to permit movement of the boom relative to the support when the support is stationary.

The end effector comprises a swivel that may comprise a rotatable core comprising the fluid conduit, a ring mounted on the core rotating with the core, and a non-rotatable housing disposed around the core. The fluid conduit may be in fluid communication with a first fluid port through the ring and a second fluid port through the housing. The fluid conduit may transport hydraulic fluid inside the swivel between the first and second fluid ports. The fluid conduit may comprise a plurality of fluid conduits. The first fluid port may comprise a first plurality of fluid ports. The second fluid port may comprise a second plurality of fluid ports. Each of the plurality of fluid conduits may fluidly connect one of the first fluid ports to one of the second fluid ports. The first fluid port may be connected to the immobilizer and/or cutter by one or more first hydraulic lines. The second fluid port may be connected to the hydraulic fluid reservoir by one or more second hydraulic lines. Rotation of the swivel continuously through 360° may not wind any of the hydraulic lines around the end effector.

The apparatus may comprise an immobilizer that reduces or prevents oscillatory motion of the object being cut. Immobilizers may include, for example, toothed elements, tensioning elements, grippers (e.g. jawed grippers) and the like. There may be one or more immobilizers, which may be the same or different.

In one embodiment, the immobilizer may be a gripper. The gripper may comprise one or more grippers. Where the gripper comprises more than one gripper, the grippers may be the same or different. The gripper may be configured to lock in position during a hydraulic failure. In one embodiment, the gripper may comprise a hydraulically-powered high gear ratio actuator configured to open and close the gripper to hold and release the object. The actuator may comprise a threaded rod drivingly connected to a hydraulic motor. The threaded rod may be matingly connected to opposed threaded apertures in opposed jaws of the gripper. Driving the threaded rod to rotate in one direction may cause the jaws to close and driving the threaded rod to rotate in an opposite direct may cause the jaws to open. In another embodiment, the gripper may comprise a hydraulic cylinder whose extension and retraction opens and closes the gripper. Ends of the hydraulic cylinder may be connected to opposed jaws of the gripper. More than one hydraulic cylinder may be used.

The end effector may comprise a head. The head may comprise the immobilizer and/or the cutter. The head may be movable up and down in a vertical plane with respect to the surface. The head may be moveable side to side in a horizontal plane with respect to the surface. The head may be rotatable about a longitudinal axis between front and rear of the head.

The end effector may comprise a hydraulically powered high gear ratio actuator configured to rotate the head about the longitudinal axis. The end effector may comprise a hydraulically powered high gear ratio actuator configured to move the head side to side. The end effector may comprise a hydraulically powered high gear ratio actuator configured to move the head up and down. The actuators may lock in position during a hydraulic failure.

One or more of the hydraulically powered high gear ratio actuators that rotate the head and move the head side to side and up and down may comprise slew drives drivingly connected to a hydraulic motor.

The cutter may comprise one or more cutters. The cutter may include any structures suitable for cutting an object, for example saws (e.g. chain saw, circular saw, reciprocating saw, etc.) and shearing elements that shear the object, for example as the gripper grips the object the gripper may also shear the object. Where the cutter comprises more than one cutter, the cutters may be the same or different.

A manifold of valves may be employed to control hydraulic fluid flow to at least the immobilizer and/or the cutter. The valves may comprise solenoids, for example center-spool solenoids. One or more of the solenoids may comprise a spring return, especially the solenoid or solenoids that control fluid flow to the cutter.

The apparatus may further comprise one or more cameras oriented to capture images of the immobilizer and/or cutter. The apparatus may further comprise one or more lights that illuminate the immobilizer and/or cutter. The apparatus may further comprise one or more controllers configured to permit control of operations of the apparatus. At least one of the one or more controllers may comprise a remote control configured to permit an operator to control operation of the apparatus from a safe location away from the apparatus. At least one of the one or more controllers may comprise an emergency stop functionality.

The apparatus may further comprise a data transmitter (e.g. wired or wireless) in electronic communication with one or more sensors on the apparatus. The data transmitter may transmit signals to remote data collection device. The one or more sensors may comprise one or more of a global positioning system, a shaft encoder on an actuator, a timer, a strain gauge, a wind speed gauge, a temperature gauge, an altimeter and a camera. The apparatus may further comprise a logic circuit configured to automatically control one or more aspects of operation of the apparatus.

The boom may comprise a plurality of arms connected at joints about which the arms are rotatable. At least one arm may be extensible. At least a portion of the boom may be electrically isolated, for example the at least a portion of the boom may be made of a non-conductive material (e.g. fiberglass, polymer composite, etc.). In one embodiment, one or more of the arms, or one or more portions of one or more of the arms, may be electrically isolated.

The apparatus of the present invention is safer than similar prior art apparatuses. The present apparatus provides reduced hydraulic line failure by reducing or eliminating failure resulting from hydraulic lines catching on branches or twisting during full 360° rotation of the end effector. Further, the present apparatus is less likely to fail when a loss of hydraulic fluid pressure at the end effector occurs. As opposed to prior art apparatuses (e.g. U.S. Pat. No. 6,408,906), high gear ratio actuators that may be employed in the present apparatus may be employed to reduce the likelihood of the immobilizer failing (e.g. the gripper opening) and dropping an object due to hydraulic pressure loss at the end effector. Furthermore, the apparatus eliminates the need for people to work at elevated locations, which eliminates the risk of a person falling.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a schematic drawing of a gripping and cutting apparatus in accordance with the present invention in a stowed configuration.

FIG. 2 depicts a schematic drawing of the apparatus of FIG. 1 with a boom deployed in several different possible operational configurations illustrating a range of motion for the boom.

FIG. 3A depicts a schematic drawing of a perspective view of an end effector of the apparatus of FIG. 1.

FIG. 3B depicts a schematic drawing of a side view of the end effector of FIG. 3A.

FIG. 3C depicts a schematic drawing of a front end view of the end effector of FIG. 3A.

FIG. 3D depicts a schematic drawing of a top view of the end effector of FIG. 3A.

FIG. 4A depicts a schematic drawing of the end effector of FIG. 3A including hydraulic lines and showing each end effector joint in a first position.

FIG. 4B depicts a schematic drawing of the end effector of FIG. 4A where each end effector joint is in a second position.

FIG. 5A depicts a schematic drawing of a side view of the end effector of FIG. 3A showing an interior of a multiport rotary hydraulic swivel connecting a head of the end effector to a main body of the end effector.

FIG. 5B depicts a schematic drawing of a cross-sectional view of the end effector of FIG. 3A taken through a longitudinal axis of the end effector.

FIG. 6A depicts a schematic drawing of a side transparent view of the multiport rotary hydraulic swivel of the end effector of FIG. 5A showing how hydraulic fluid is transported between fluid ports on a non-rotatable casing to fluid ports on a rotatable ring of the swivel.

FIG. 6B depicts a schematic drawing of a cross-sectional view of the multiport rotary hydraulic swivel shown in FIG. 6A taken through a longitudinal axis of the swivel.

FIG. 6C depicts a schematic drawing of an end view of a cross-sectional view through A-A of the multiport rotary hydraulic swivel shown in FIG. 6A perpendicular to the longitudinal axis of the swivel.

FIG. 6D depicts a schematic drawing of a perspective view of FIG. 6C.

FIG. 6E depicts a schematic drawing of an exploded view of the multiport rotary hydraulic swivel shown in FIG. 6A.

FIG. 7A depicts a schematic drawing of a rear perspective view of first and second high gear ratio slew drives configured to move the end effector of FIG. 3A up and down at a first end effector joint and left and right at a second end effector joint.

FIG. 7B depicts a schematic drawing of a front right side perspective view of FIG. 7A.

FIG. 7C depicts a schematic drawing of a front left side perspective view of FIG. 7A.

FIG. 7D depicts a schematic drawing of a high gear ratio slew drive configured to rotate a head of the end effector of FIG. 3A through 360°.

FIG. 7E depicts a schematic drawing of a cross-sectional view of a high gear ratio slew drive.

FIG. 8A depicts a schematic drawing of a perspective view of a head of the end effector of FIG. 3A with jaws of a jawed gripper in an open position and a chain saw in a non-cutting position.

FIG. 8B depicts a schematic drawing of a front end view of the head of FIG. 8A.

FIG. 8C depicts a schematic drawing of a perspective view of the head of FIG. 8A with the jaws of the jawed gripper in a closed position holding a tree branch and the chain saw in a cutting position after having cut the tree branch.

FIG. 9A depicts a schematic drawing of a side perspective view of a first alternative embodiment of a head, the head having a jawed gripper with jaws open and a chain saw in a non-cutting position.

FIG. 9B depicts a schematic drawing of the head of FIG. 9A from an opposite side.

FIG. 9C depicts a schematic drawing of a front view of the head of FIG. 9A.

FIG. 9D depicts a schematic drawing of a side perspective view of the head of FIG. 9A with the jaws closed.

FIG. 10A depicts a schematic drawing of a side perspective view of a second alternative embodiment of a head, the head having a toothed immobilizer and a chain saw in a non-cutting position.

FIG. 10B depicts a schematic drawing of the head of FIG. 10A with the chain saw entering into a cutting position.

FIG. 10C depicts a schematic drawing of the head of FIG. 10A with a side removed to show components inside the head.

FIG. 10D depicts a schematic drawing of the head of FIG. 10C from an opposite side.

FIG. 11A depicts a schematic drawing of a side perspective view of a third alternative embodiment of a head, the head having two chain saws and a gripper.

FIG. 11B depicts a schematic drawing of an opposite side perspective view of the head of FIG. 11A.

FIG. 12A depicts a schematic drawing of a side perspective view of a fourth alternative embodiment of a head, the head having a reciprocating saw in a non-cutting position, but no gripper.

FIG. 12B depicts a schematic drawing of the head of FIG. 12A from an opposite side and with the reciprocating saw in a cutting position.

FIG. 12C depicts a schematic drawing of the head of FIG. 12B with a side removed to show components inside the head.

FIG. 12D depicts a schematic drawing of the head of FIG. 12C from an opposite side.

FIG. 13A depicts a schematic drawing of a side perspective view of a fifth alternative embodiment of a head, the head having a pair of circular saws in a non-cutting position.

FIG. 13B depicts a schematic drawing of the head of FIG. 13A with the circular saws in a cutting position.

FIG. 13C depicts a schematic drawing of the head of FIG. 13B with a side removed to show components inside the head.

FIG. 13D depicts a schematic drawing of the head of FIG. 13C from an opposite side.

### DETAILED DESCRIPTION

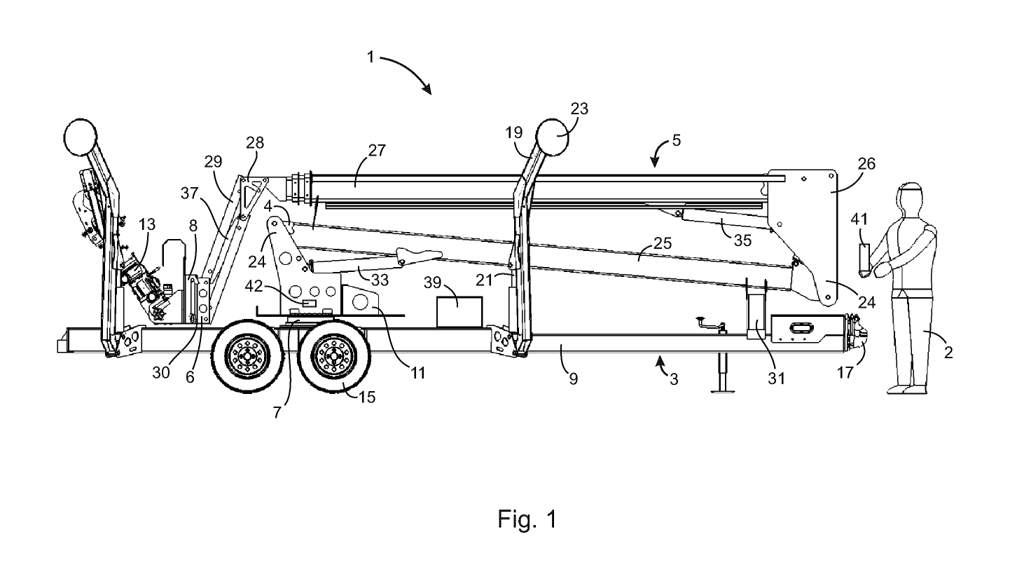

With reference to FIG. 1, a gripping and cutting apparatus 1 in accordance with one embodiment of the present invention is shown in a stowed configuration. The apparatus 1 comprises a trailer 3, an articulated boom 5 rotatably mounted and supported on the trailer 3 via a rotatable mount 7 at a near end 4 of the boom 5, and an end effector 13 mounted at a far end 6 of the boom 5 via an end effector mount 8. The end effector 13 comprises a gripper and a cutter as more fully described below. The rotatable mount 7 is secured to a frame 9 of the trailer 3 and to a base 11 of the boom 5 at the near end 4 of the boom 5. The rotatable mount 7 may be capable of rotating continuously through 360°. That is, the rotatable mount 7 may be able to rotate 360° over and over in the same direction. Continuous 360° rotation may be accomplished with a multiport rotary hydraulic swivel operatively connecting the mount 7 to the frame 9 of the trailer 3. In the event that continuous 360° rotation of the mount 7 is desired, a slip ring or other arrangement may be provided on the mount 7 to accommodate any electrical connections from other components on the trailer 3 to the end effector 13 reducing the possibility of electrical cables getting tangled as the mount 7 rotates.

The trailer 3 rides on wheels 15 (only one labeled) and may be towed by a vehicle (not shown) by hitching the trailer 3 to the vehicle at hitch 17. Instead of or in addition to wheels, the trailer may be provided with tracks, sliders (e.g. skis), pontoons, boat hulls or other travel-surface-engaging elements to facilitate travel over various kinds of terrain. Travel-surface-engaging elements may be self-propelled, if desired, receiving power from any suitable source, for example a motor (e.g. electric, hydraulic and/or internal combustion motors). The towing vehicle may be any desired vehicle suitable for the terrain, for example a truck, a tractor, a snow cat, a motor boat and the like. The trailer may be further equipped with brakes, for example surge or electric brakes, to assist in stopping the trailer. The type of brakes most suitable for a particular trailer may depend on the type of motion that the trailer experiences while being towed, the type of travel-surface-engaging elements on which the trailer rides and the type of towing vehicle. For example, for a tractor-towed trailer in a park-like setting where the trailer has non-powered tracks, surge brakes may be more appropriate.

When the apparatus 1 is in use, the trailer 3 may be stabilized on a surface (e.g. the ground) by stabilizer legs 19 (only one labeled). In this embodiment four stabilizer legs 19 are present, although more or fewer stabilizer legs may be employed. The stabilizer legs 19 may be raised and lowered by any suitable mechanism, for example leg hydraulic cylinders 21 (only one labeled). FIG. 1 shows the stabilizer legs 19 in a stowed raised position with the feet 23 (only one labeled) off the ground. Lowering the stabilizer legs 19 causes the feet 23 to engage the ground and partially or fully lift the wheels 15 of the trailer 3 off the ground so that the trailer 3 cannot roll on the wheels 15.

One or more of the stabilizer legs, preferably all of the stabilizer legs, may further be adjustable in length. The length of the stabilizer legs may be adjustable between a fully retracted position and a fully extended position. Further, length adjustment of the stabilizer legs may be effected in one or more spatial directions. For example, the stabilizer legs may be length adjustable in both a horizontal direction parallel to the ground and a vertical direction perpendicular to the ground. Such multi-directional length adjustment may improve the ability of the stabilizer legs to support the trailer on uneven surfaces. Length adjustability in any of the directions may be accomplished in any suitable manner, for example with suitably oriented telescoping leg sections coupled to actuators (e.g. hydraulic cylinders).

Confirmation of the positions of the stabilizer legs (e.g. retracted, extended or in-between) may be determined by sensors, for example inductive proximity sensors, which send signals to a controller on the apparatus. Length adjustability of the stabilizer legs may be configured to operate in tandem. For example, the stabilizer legs on one side of the trailer may only extend and retract in unison, separately from extension and retraction of the stabilizer legs on the other side of the trailer, which may also extend and retract in unison with each other. The positions of the stabilizer legs are preferably determined prior to lowering the stabilizer legs to ground-engaging positions. Once the stabilizer legs are on the ground, length adjustment may not be allowed. The stabilizer legs may also be equipped with a levelling functionality, desirably an auto-levelling functionality. Levelling functionality may operate regardless of the length adjustment position of the stabilizer legs. All operations of the stabilizer legs may be controlled by a controller on the apparatus, and the controller may be programmed with suitable logic to automatically control the operation of the stabilizer legs. Adjustable stabilizer legs enable the apparatus to be utilized in a wider range of work applications, therefore giving the user more flexibility when setting up the apparatus.

Length adjustability of the stabilizer legs makes it desirable to apply certain height and reach limitations on the apparatus to ensure stability of the apparatus in all setup configurations. The particular limitations to be applied may depend upon the combination of extended and retracted (paired) stabilizer legs, as illustrated in the following examples. In a Normal Position (all stabilizer legs extended), no limitations are applied to height and reach capabilities of the apparatus. In a Compact Position (all stabilizer legs retracted), height and reach capabilities are reduced to ensure stability of the apparatus. In a Short Left-Side (SLS) Position (left-side stabilizer legs retracted and right-side stabilizer legs extended), the apparatus is allowed to operate within a 180° operating arc on the right-side of the apparatus only and height and reach limitations are also applied. In a Short Right-Side (SRS) Position (right-side stabilizer legs retracted and left-side stabilizer legs extended), the apparatus is allowed to operate within a 180° operating arc on the left-side of the apparatus only and height and reach limitations are also applied.

The boom 5 comprises three arms 25, 27, 29. Arm 25 is pivotally connected to the base 11 at joint 24 and pivotally connected to arm 27 at joint 26. The arm 27 is pivotally connected to the arm 25 at joint 26 and pivotally connected to arm 29 at joint 28. The arm 29 is pivotally connected to the arm 27 at joint 28 and pivotally connected at joint 30 to the end effector mount 8. Pivoting of the arms 25, 27, 29 causes the boom 5 to unfold or refold. In the stowed position, the arm 25 may be secured to the trailer 3 with securing bracket 31 to ensure that the boom 5 does not move unduly during transport. The apparatus 1 may comprise more than one securing bracket. The arms 25, 27, 29 may be pivoted by any suitable mechanism, for example arm hydraulic cylinders 33, 35, 37.

Hydraulic fluid reservoir 39 mounted on the trailer 3 supplies hydraulic fluid to all hydraulically components through a plurality of hydraulic lines (not shown). An operator 2 may remotely control operation of the apparatus 1 using a wireless remote control 41 or a controller 42 located on the apparatus 1. When the apparatus 1 is parked as shown in FIG. 1, a sensor (not shown) may be configured to activate a failsafe to prevent operation of the end effector 13. The failsafe may be configured to enable manual override in order to operate the end effector 13 for purposes of maintenance, testing, etc., if desired.

Although the boom is depicted mounted on a trailer outfitted with stabilizer legs, any suitably stable support may be employed to support the boom, for example, a non-movable platform, a powered vehicle (e.g. a truck) and the like.

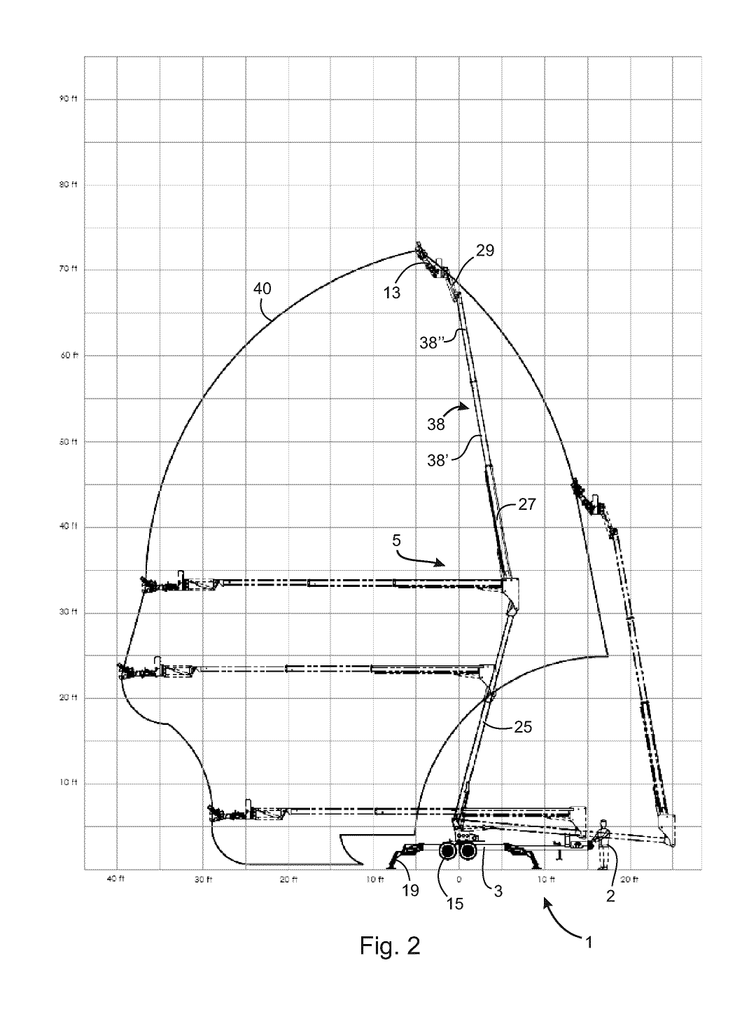

With reference to FIG. 2, the gripping and cutting apparatus 1 may be deployed in a wide variety of operational configurations, a few of which are illustrated in FIG. 2. By lowering the stabilizer legs 19 (only one labeled), the trailer 3 may be lifted so that the wheels 15 are lifted off the ground to prevent movement of the trailer 3 during operation. The articulated boom 5 may be unfolded so that the arms 25, 27, 29 may achieve a variety of configurations resulting in a variety of different positions relative to the ground that the end effector 13 can achieve. Trace line 40 illustrates one potential path along which the end effector 13 may travel while the articulated boom 5 unfolds and refolds. Five of the possible positions along trace line 40 are illustrated, one in solid lines and four in dotted lines. In addition, one or more arms 25, 27, 29 may be extensible. For example, one or more of the arms 25, 27, 29 may be telescoping. A telescoping arm may preferably comprise an arm-within-arm arrangement whereby an internal arm is extended out (or retracted into) an outer arm, for example with use of a hydraulic cylinder in the arm. FIG. 2 illustrates telescopic extension of arm 27 with extension portion 38. Further, the extension portion 38 may comprise an arm-within-arm telescoping arrangement illustrated as further extension portions 38′ and 38″. In the embodiment illustrated in FIG. 2, the end effector 13 may achieve a height from the ground of over 70 feet, and may reach as much as 40 feet or more to a side. With proper control, the apparatus 1, including the boom 5 and stabilizer legs 19, may be deployed to a functioning position with the boom 5 at 80 feet in about 2 minutes. Different paths and positions for the end effector 13 may be achieved using different combinations of unfolding and telescoping.

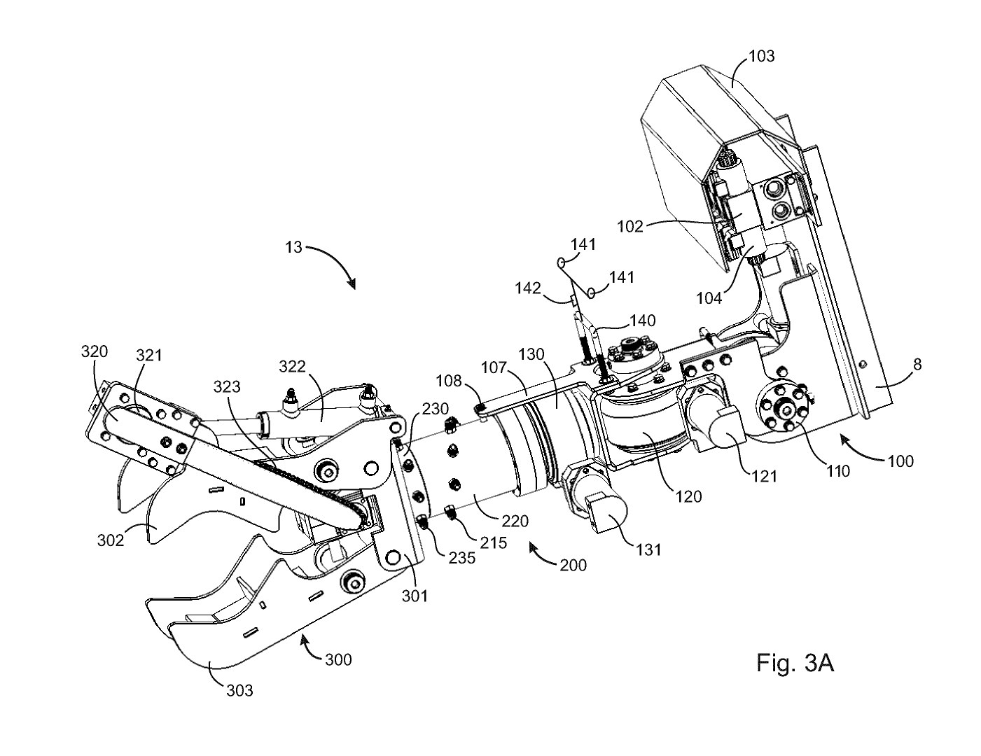

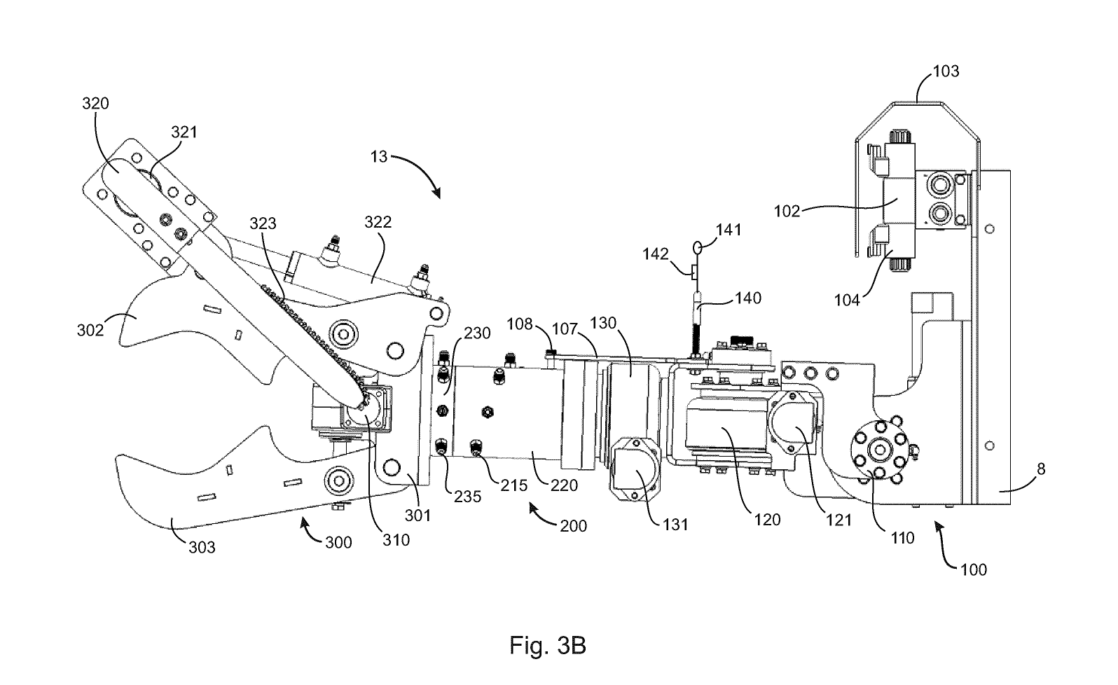

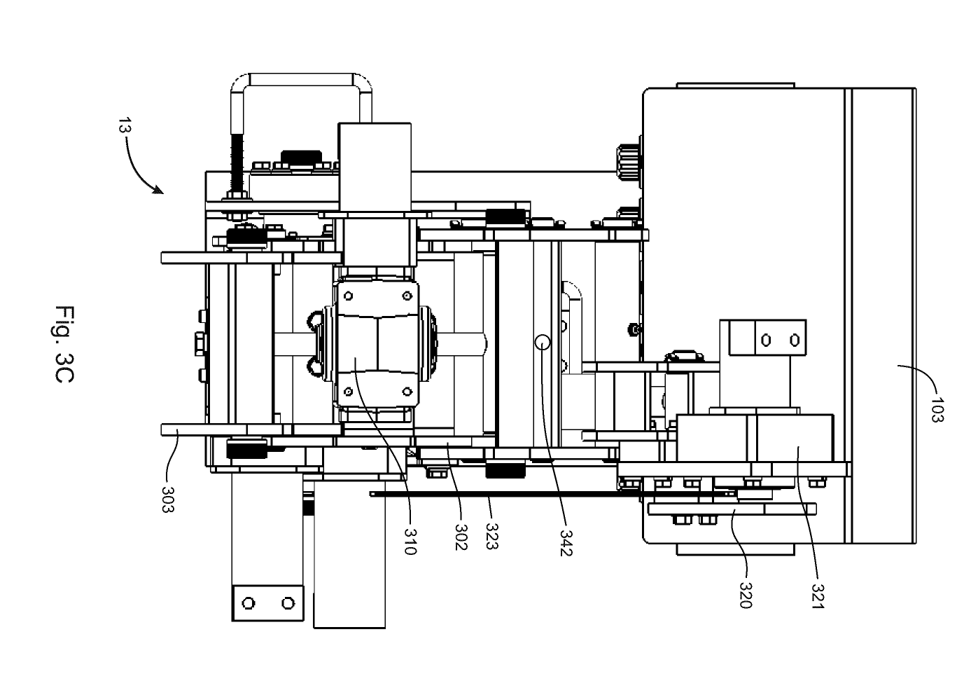

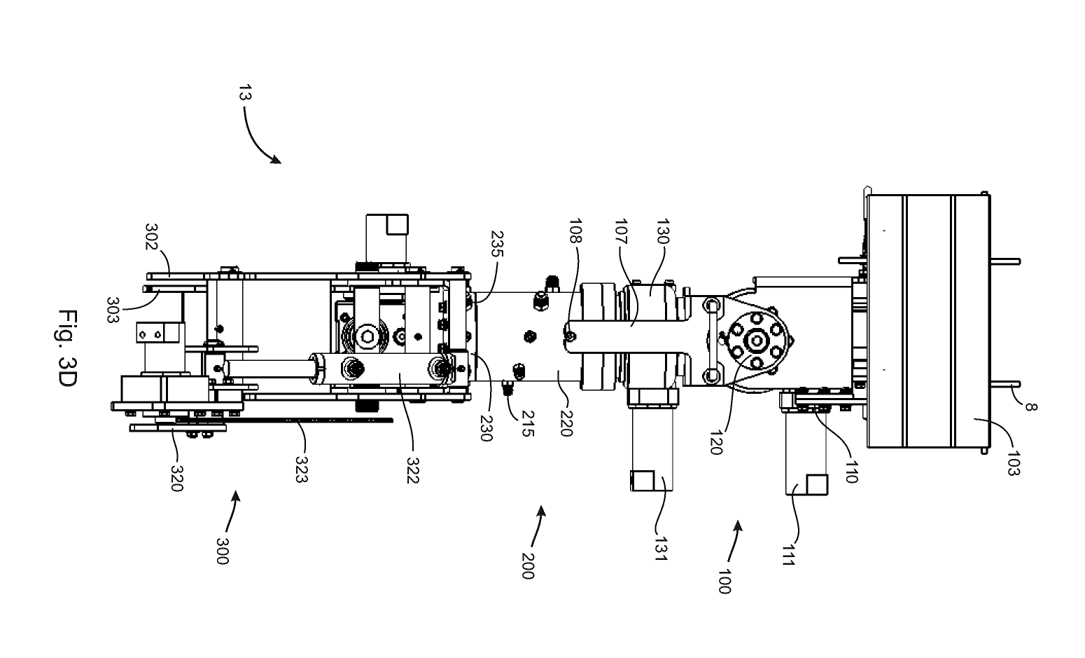

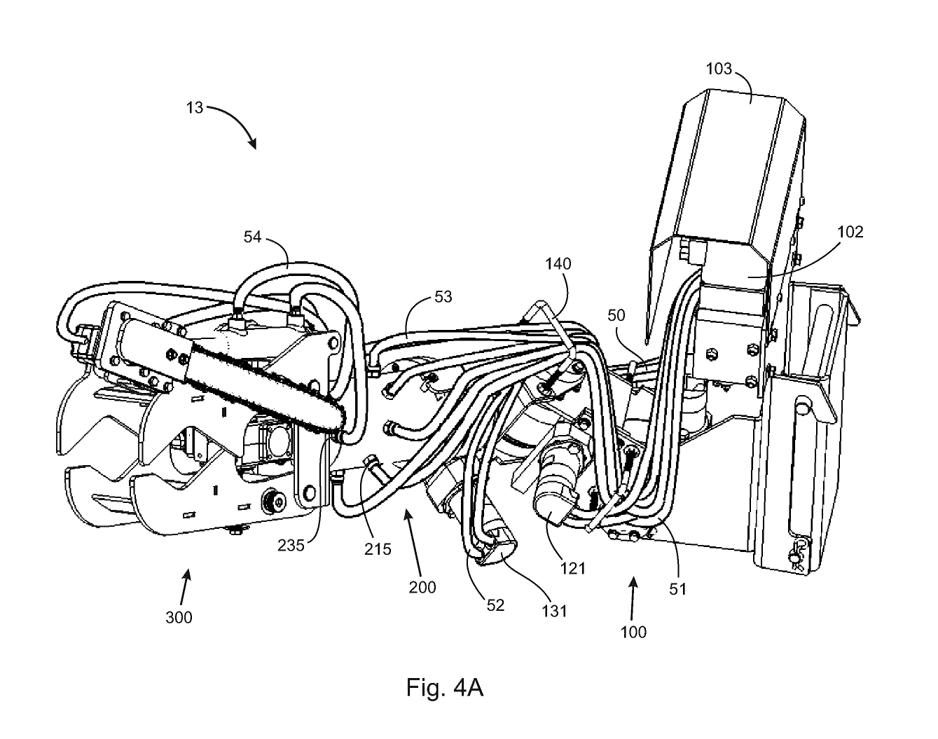

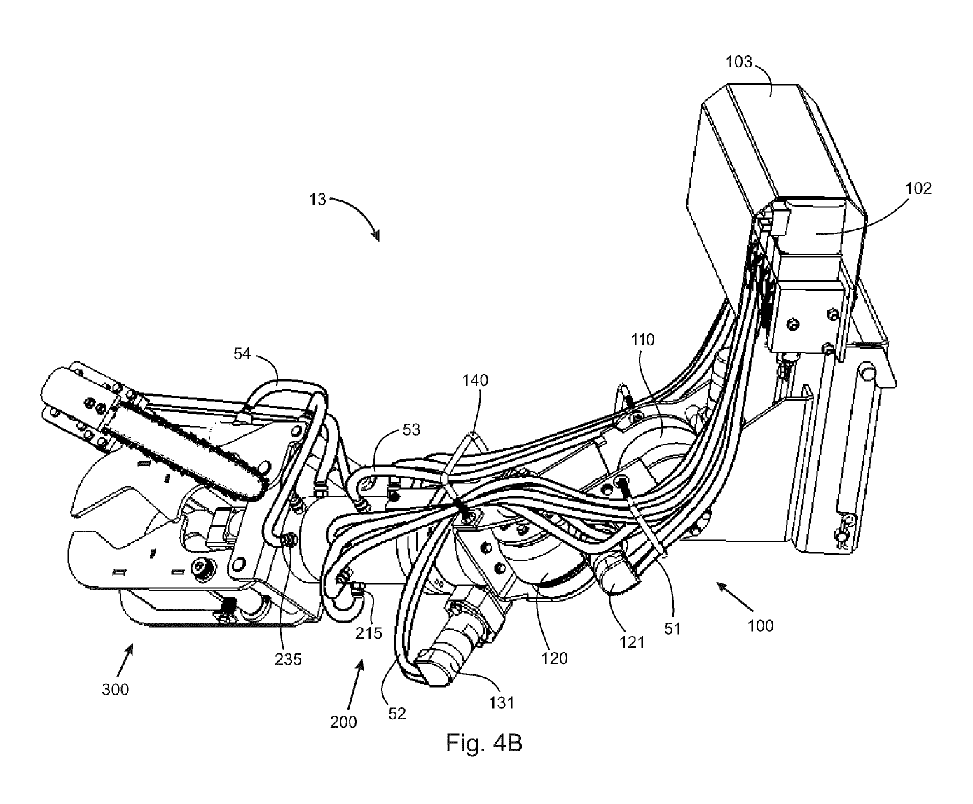

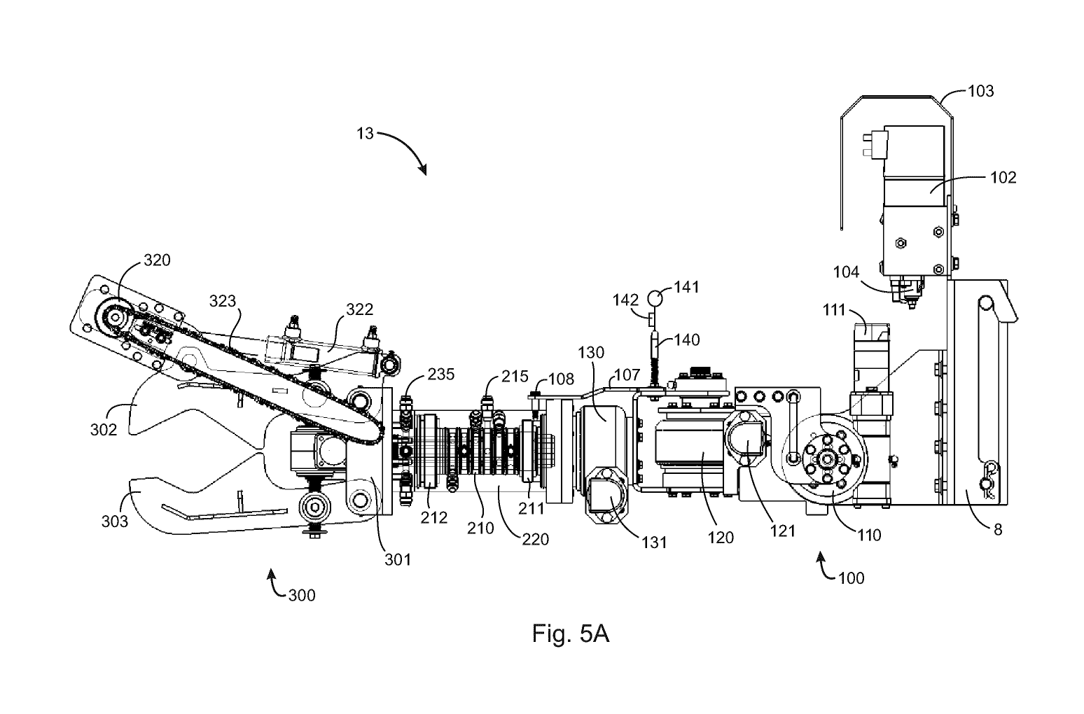

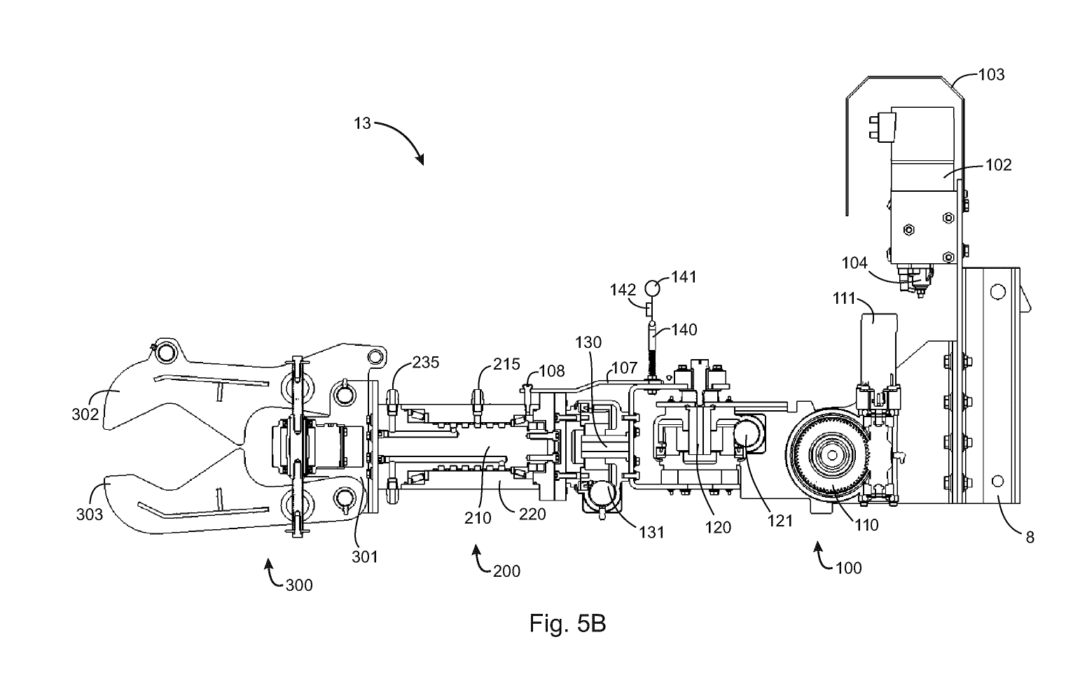

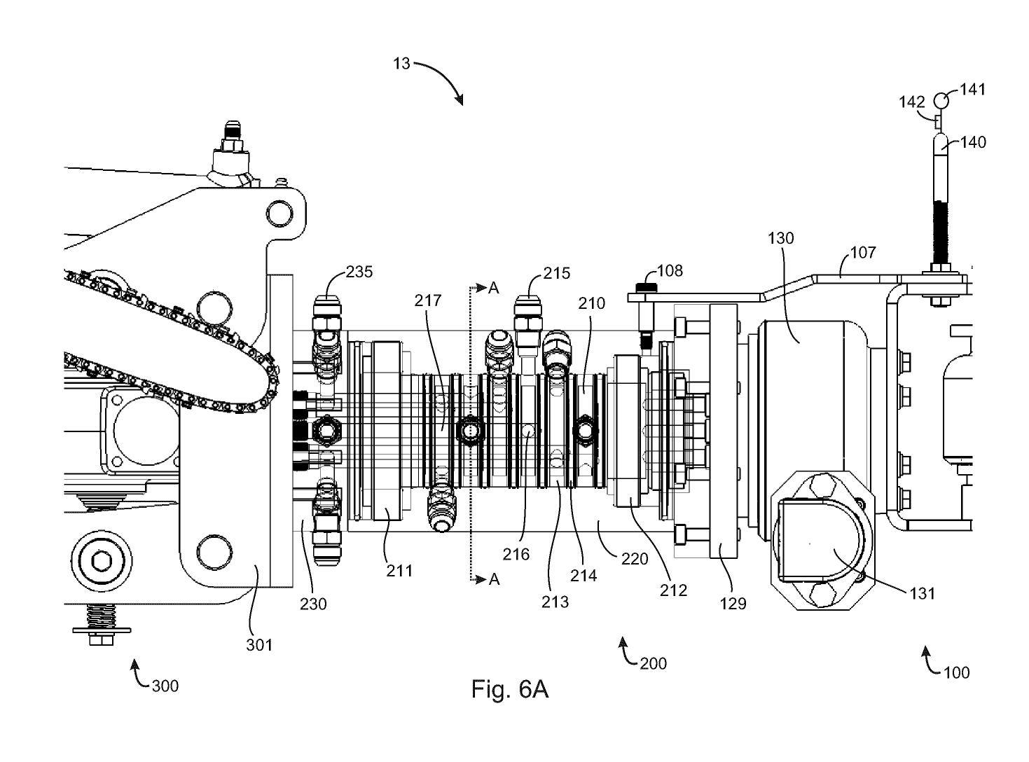

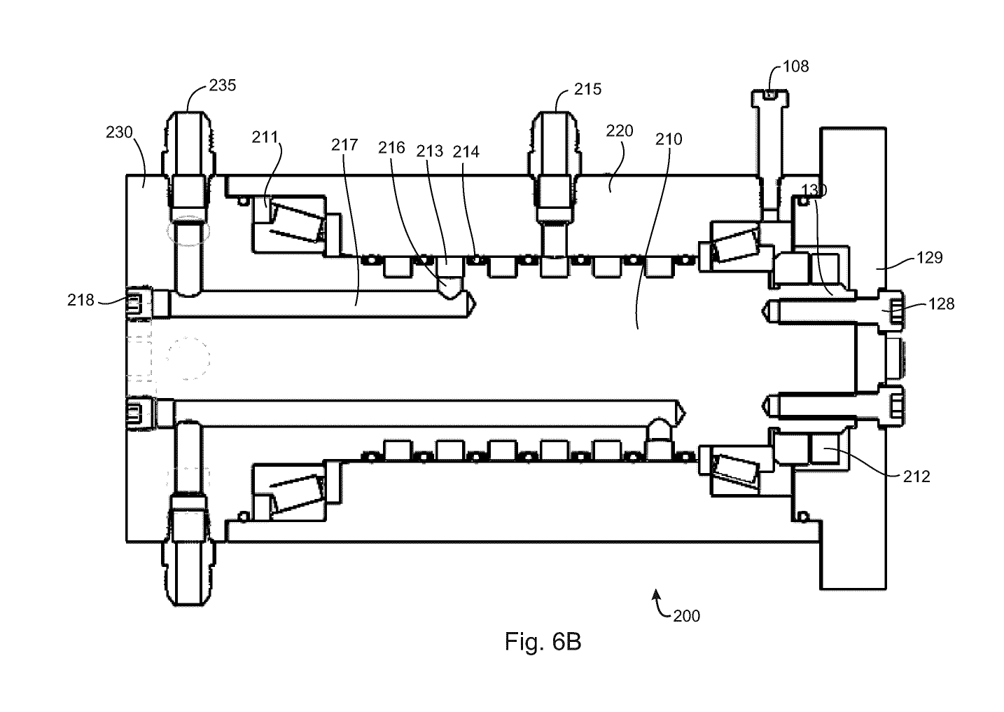

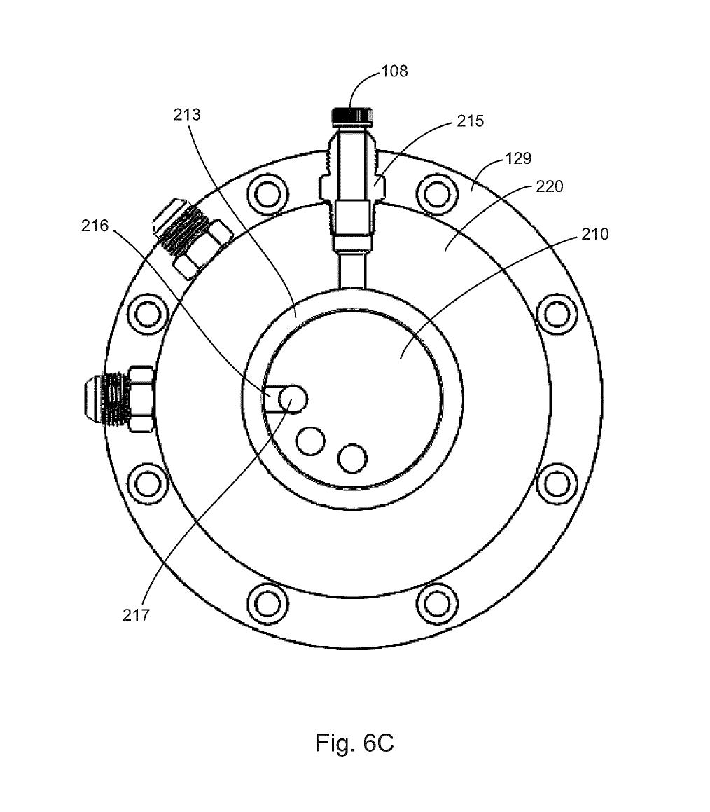

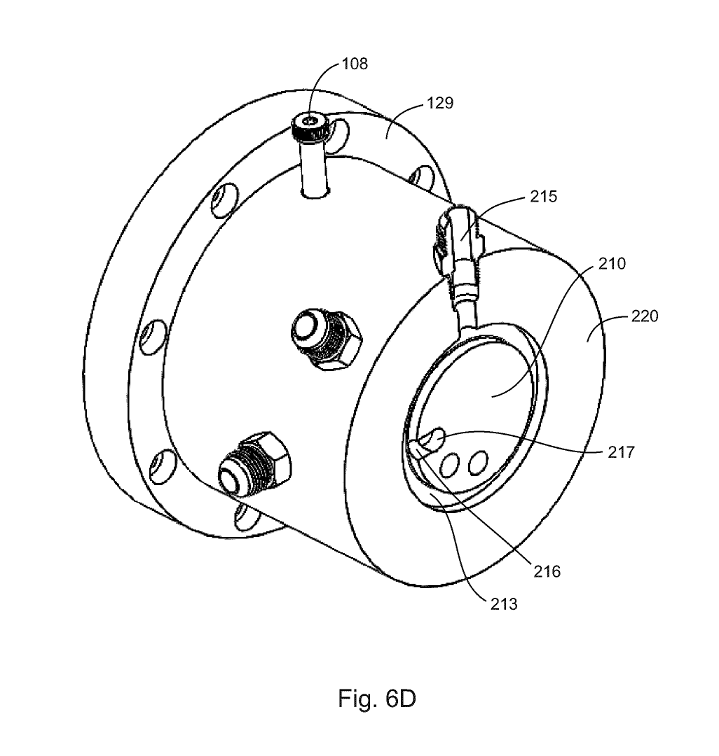

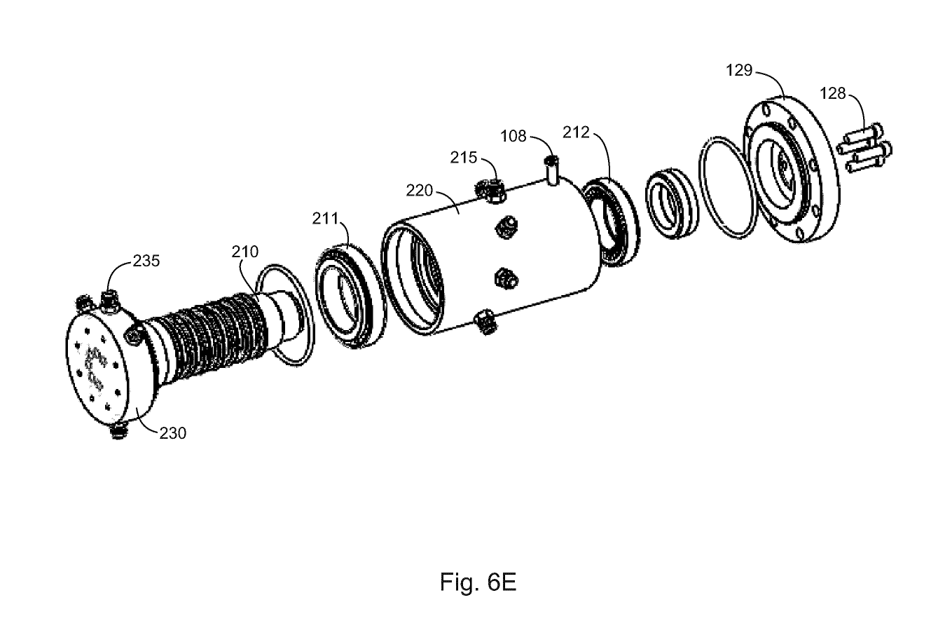

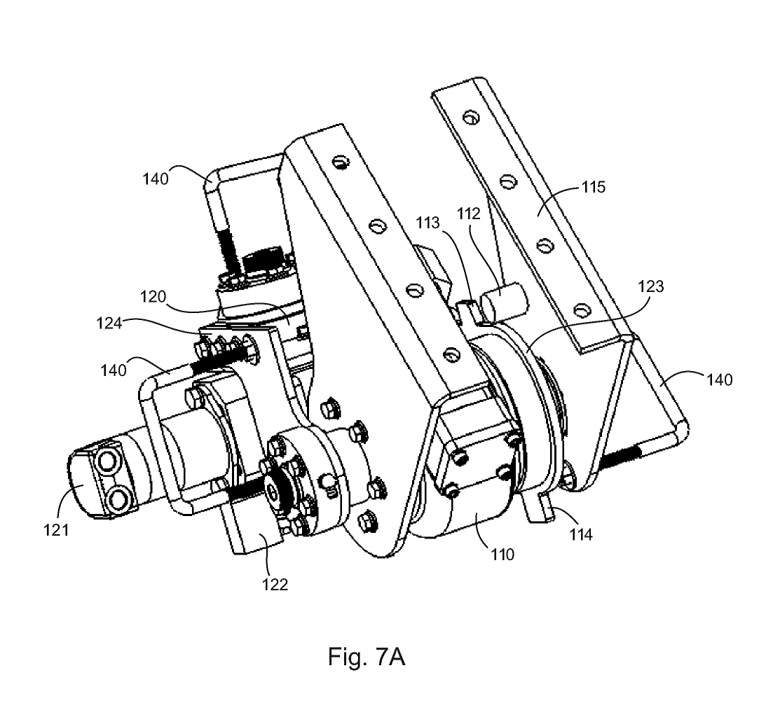

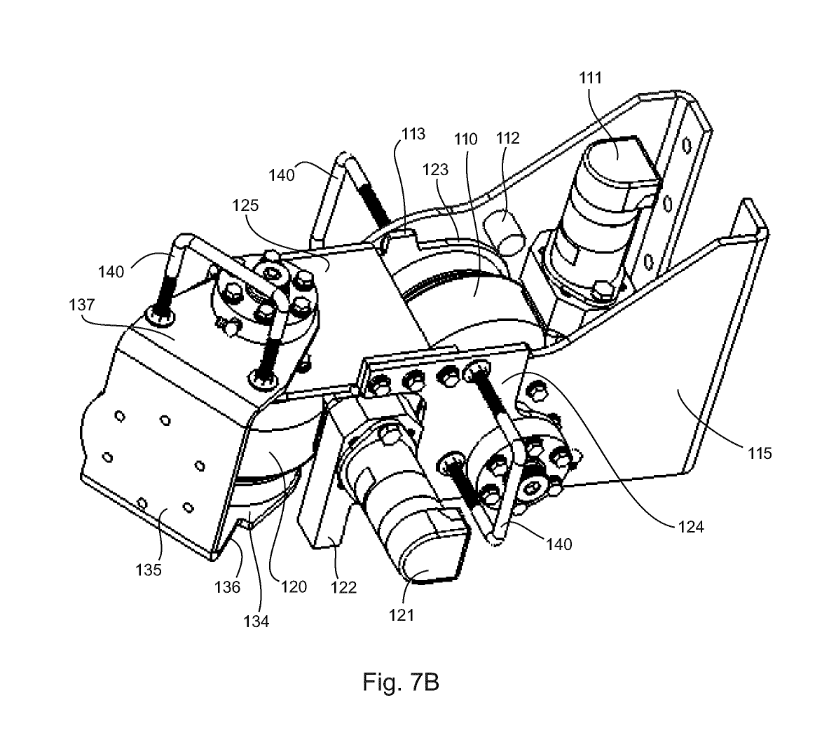

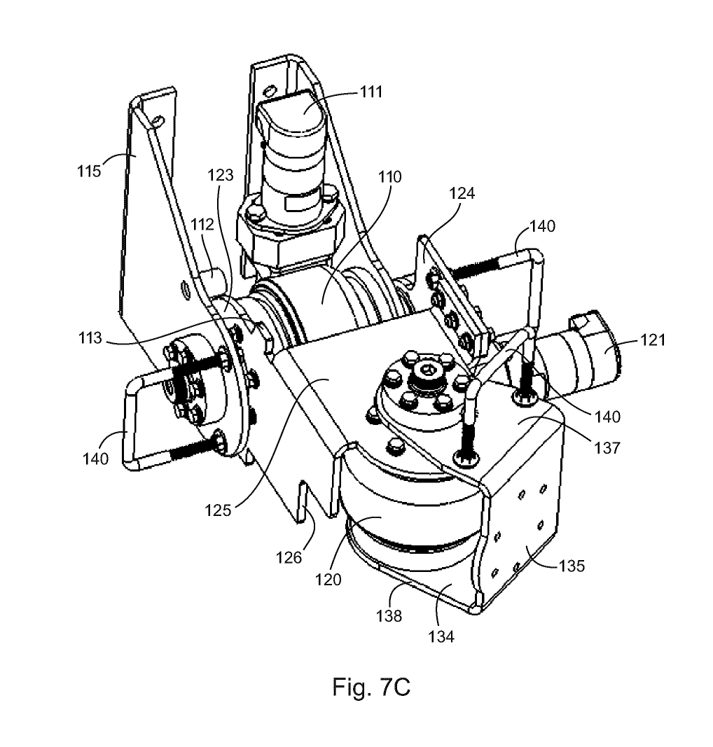

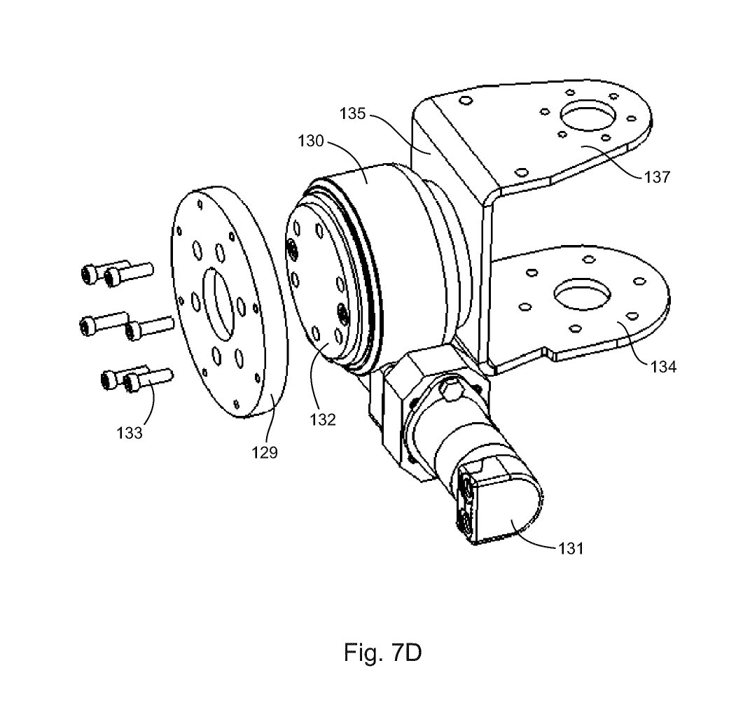

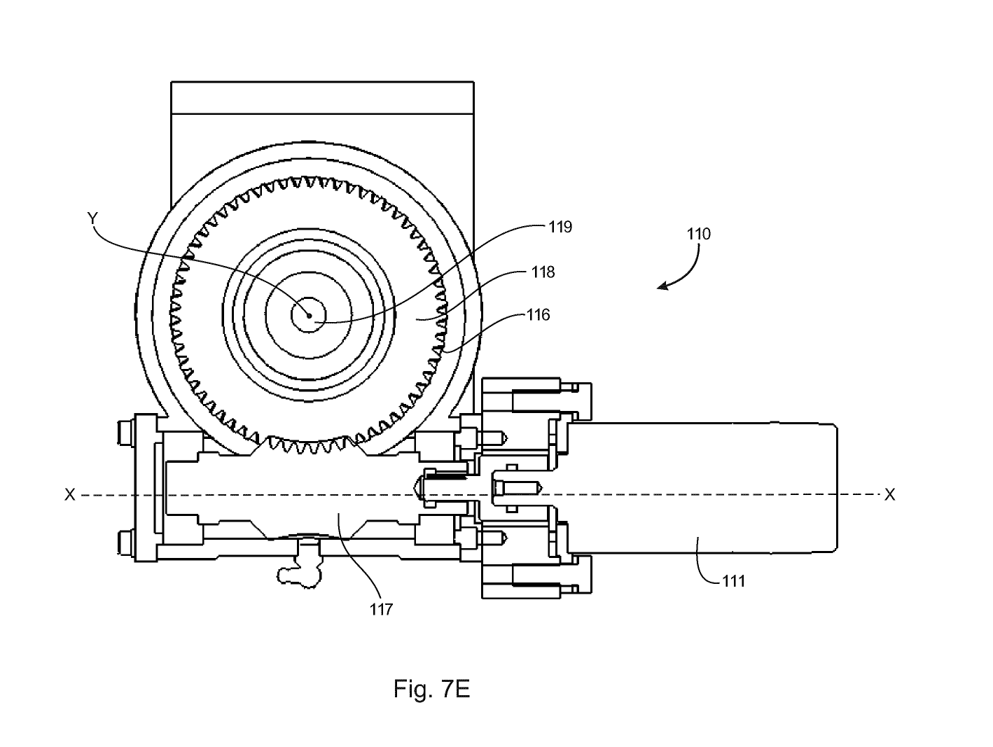

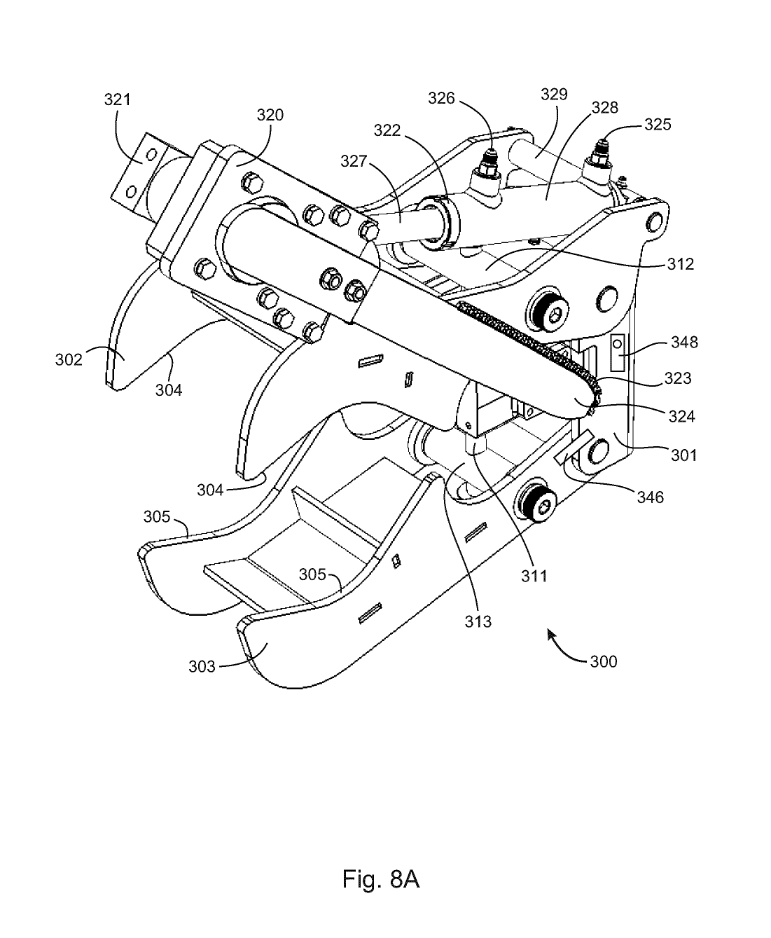

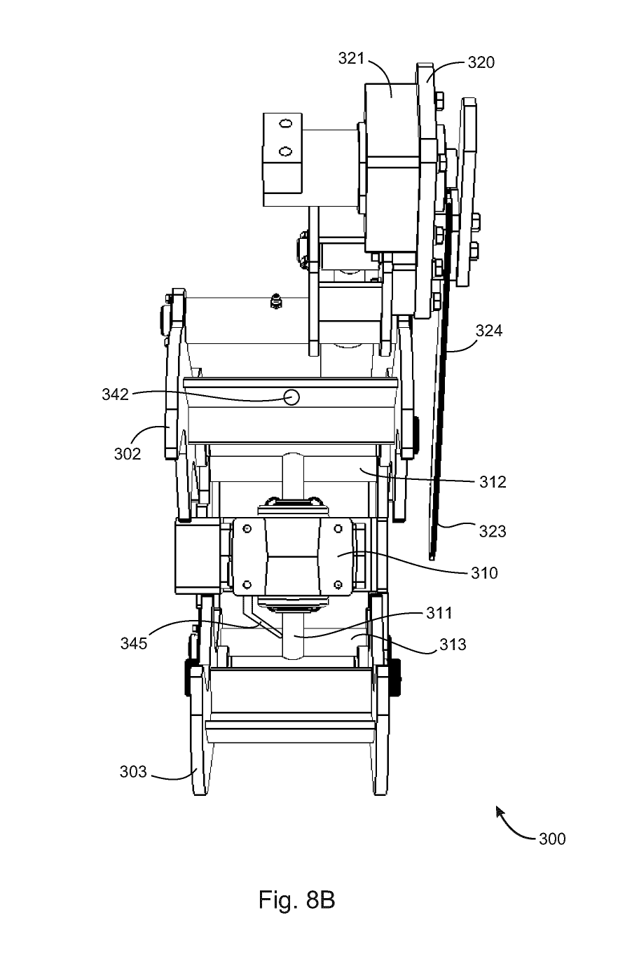

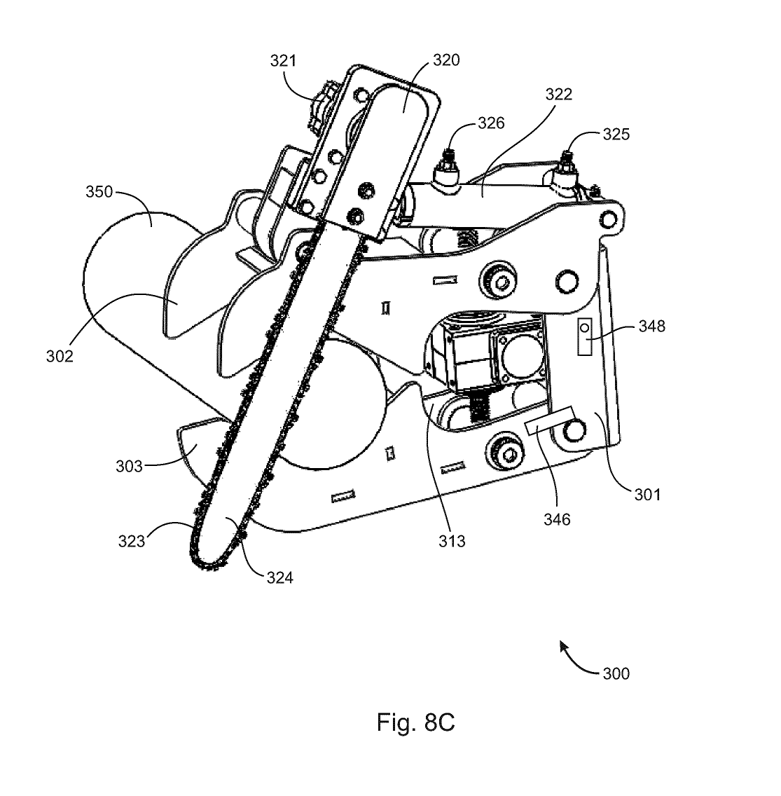

FIG. 3A, FIG. 3B, FIG. 3C, FIG. 3D, FIG. 4A, FIG. 4B, FIG. 5A, FIG. 5B, FIG. 6A, FIG. 6B, FIG. 6C, FIG. 6D, FIG. 6E, FIG. 7A, FIG. 7B, FIG. 7C, FIG. 7D, FIG. 7E, FIG. 8A, FIG. 8B, and FIG. 8C illustrate an embodiment of the end effector 13 and components thereof. The end effector 13 may comprise a main body 100, a head 300 and a multiport hydraulic swivel 200 disposed between the main body 100 and the head 300. The end effector mount 8, for mounting the end effector 13 on the far end of the articulated boom as described above, may be conveniently mounted on a rear end of the main body 100.

In addition to the end effector mount 8, the main body 100 may comprise a hydraulic valve manifold 102 housed under a valve manifold cover 103. The hydraulic valve manifold 102 comprises a sufficient number of hydraulic valves to run all of the hydraulic operations of the end effector 13. The hydraulic valves receive hydraulic fluid from one or more main hydraulic lines that extend from the hydraulic fluid reservoir on the trailer, along the boom to arrive at the hydraulic valve manifold 102. In this embodiment, the hydraulic valve manifold 102 comprises six center-spool solenoids 104 (only one labeled), each of the solenoids 104 comprising an inlet and outlets, the inlet receiving hydraulic fluid from the hydraulic fluid reservoir and the outlets providing hydraulic fluid to hydraulically operated parts of the end effector 13. The hydraulic valve manifold 102 with center-spool solenoids 104 may be any suitable commercially available device, for example a Bosch Type M4-12 load sensing control block.

In the illustrated embodiment, a first solenoid controls hydraulic fluid pressure at a first hydraulic motor drivingly connected in a first high gear ratio slew drive 110 for driving up and down motion of the end effector 13 at a first end effector joint. A second solenoid controls hydraulic fluid pressure at a second hydraulic motor drivingly connected in a second high gear ratio slew drive 120 for driving right and left motion of the end effector 13 at a second end effector joint. A third solenoid controls hydraulic fluid pressure at a third hydraulic motor drivingly connected in a third high gear ratio slew drive 130 for driving rotation of the head 300 of the end effector 13 at a third end effector joint. A fourth solenoid controls hydraulic fluid pressure at a fourth hydraulic motor in a high gear ratio screw drive 310 for driving opening and closing of opposed jaws 302, 303 of a jawed gripper 301. A fifth solenoid controls hydraulic fluid pressure at a hydraulic motor 321 of a chain saw 320 for switching the chain saw 320 on and off. A sixth solenoid controls hydraulic fluid pressure at a dual acting hydraulic cylinder 322 for engaging and disengaging a cutting chain 323 of the chain saw 320 with an object being held in the opposed jaws 302, 303 of the jawed gripper 301.

Hose guides 140 (only one labeled) may be used to retain and organize hydraulic lines extending from the hydraulic valve manifold 102 to hydraulic fluid ports 215 (only one labeled) located on the swivel 200. One or more of the hose guides 140 may also serve as convenient locations to mount one or more lights 141 and/or cameras 142 oriented to illuminate and/or image the jawed gripper 301 and chain saw 320 during operation. The camera or cameras 142 may be for taking still and/or video images, and permit a remote operator to see what is being cut and to monitor the gripping and cutting operation. For example, using the camera 142, the operator is able to target a desired branch for cutting and is able to ensure that the gripper 301 and chain saw 320 are in the correct orientation.

The multiport hydraulic swivel 200 disposed between the main body 100 and the head 300 is best illustrated in FIG. 6A, FIG. 6B, FIG. 6C, FIG. 6D and FIG. 6E. The swivel 200 may comprise a rotatable cylindrical body 210 disposed inside a non-rotatable casing 220. The rotatable cylindrical body 210 is drivingly connected to the third slew drive 130 so that rotation of the drive 130 rotates the cylindrical body 210 inside the casing 220. The cylindrical body 210 may be fixedly mounted on the head 300 so that rotation of the cylindrical body 210 causes rotation of the head 300. The cylindrical body 210 may be supported by bearings 211, 212 mounted inside the casing 220, permitting the cylindrical body 210 to rotate freely within the casing 220. The casing 220 may be prevented from rotating by being fixedly mounted to the main body 100 in any suitable way, for example by a mounting bracket 107 with a bolt 108. The cylindrical body 210 may be mounted to the third slew drive 130 by fixedly securing the cylindrical body 210 to a mounting plate 129, for example with bolts 128, and fixedly securing the mounting plate 129 to a rotating face 132 of the slew drive 130 (see FIG. 6B, FIG. 6E and FIG. 7D in particular).

The cylindrical body 210 may comprise a series of concentric annular channels 213 (only one labeled) on an outer surface of and around a circumference of the cylindrical body 210. The number of channels 213 depends on the number of hydraulic ports required to operate hydraulic devices on the head 300. In this embodiment, there are six annular channels 213. The annular channels 213 are spaced apart longitudinally along the surface of the cylindrical body 210 and are separated by channel walls as well as O-rings 214 (only one labeled) situated at tops of the walls separating the channels 213. The casing 220 may have a thickness sufficient so that an inner wall of the casing 220 forms a seal with the O-rings 214. Hydraulic fluid ports 215 (only one labeled of six) through the casing are situated above the channels 213 to provide hydraulic fluid to each channel 213 from the hydraulic valve manifold 102 (see FIG. 5A and FIG. 5B). In this embodiment, there are six hydraulic fluid ports 215 annularly and longitudinally spaced around and on the casing 220, one for each of the six channels 213. Hydraulic fluid is maintained in each channel 213 and prevented from entering neighbouring channels by the O-rings 214.

Each channel 213 may comprise an aperture 216 (only one labeled) that leads into a longitudinal conduit 217 (only one labeled of six) through an interior of the cylindrical body 210. Hydraulic fluid received from ports 215 and maintained in the channels 213 may flow through the apertures 216 and then though the conduits 217. The swivel 200 may further comprise an annular ring 230, which is mounted on or forms part of the cylindrical body 210, and which rotates with the cylindrical body 210. The annular ring 230 may be in the form of a disc. The annular ring 230 may be disposed between the casing 220 and the head 300, and the annular ring 230 may be fixedly mounted on the head 300, for example by bolts, so that rotation of the ring 230 causes the head 300 to rotate. Hydraulic fluid ports 235 (only one labeled of six) through the ring 230 may be in fluid communication with the longitudinal conduits 217 so that hydraulic fluid which entered the swivel 200 through ports 215 on the non-rotatable casing 220 and flowed through the longitudinal conduits 217 in the rotatable cylindrical body 210 may exit the swivel 200 through ports 235 on the rotatable ring 230. Plugs 218 (only one labeled) seal the ends of the longitudinal conduits 217 where the longitudinal conduits 217 were machined into the cylindrical body 210 to ensure that hydraulic fluid in the longitudinal conduits 217 enters the ports 235 without leaking out. In this way, with reference to FIG. 4A and FIG. 4B, hydraulic lines 50, 51, 52 and 53 (only one of each labeled) connecting the hydraulic valve manifold 102 to a hydraulic motor 111 (see FIG. 5A) of the first slew drive 110, to a hydraulic motor 121 of the second slew drive 100, to a hydraulic motor 131 of the third slew drive 130 and to the swivel 200 do not rotate as the head 300 rotates, respectively, while hydraulic lines 54 (only one labeled) connecting the swivel 200 to hydraulically operated devices on the head 300 do rotate with the head 300. It is evident from FIG. 4A and FIG. 4B that this arrangement permits 360° continuous rotation of the head 300 as well as up/down and right/left motion of the end effector 13 without wrapping hydraulic lines 50, 51, 52, 53 and 54 around the end effector 13. This arrangement also reduces overall length of hydraulic lines, and reduces the risk of entangling of the hydraulic lines thereby reducing the probability that hydraulic lines will get caught in branches and other obstructions. Hydraulic lines in the present arrangement are less prone to damage, damaged lines being more prone to causing hydraulic pressure failure.

The first, second and third high gear ratio slew drives 110, 120, 130 are illustrated in FIG. 7A, FIG. 7B, FIG. 7C, FIG. 7D The first and second slew drives 110, 120, which control up/down and left/right motion, respectively of the end effector 13, are illustrated in FIG. 7A, FIG. 7B and FIG. 7C. The third slew drive 130, which controls rotation of the head 300, is illustrated in FIG. 7D. An interior of the slew drive 110, which illustrates the interior of the other slew drives, is illustrated in FIG. 7E.

With reference especially to FIG. 7A, FIG. 7B, FIG. 7D and FIG. 7E, the first slew drive 110 may be mounted in a first slew drive mounting bracket 115. To fix the entire end effector 13 on the boom 5 of the apparatus, the first slew drive mounting bracket 115 may be fixedly mounted to end effector mount 8 as described above. A rotating face of the first slew drive 110 may be fixedly mounted to a planetary gear 118 of the slew drive 110, and the gear 118 mounted on a rotatable axle 119 (see FIG. 7E) The rotating face may be fixedly mounted on a first flange 123 of a second slew drive mounting bracket 125 and the rotating axle 119 may be fixedly mounted on a second flange 124 of a second slew drive mounting bracket 125. The gear 118 and therefore the rotating face and the axle 119 of the first slew drive 110 may be driven by the hydraulic motor 111 in one direction or a reverse direction. For the first slew drive 110, a face plane of the gear 118 is oriented vertically and longitudinally, therefore rotation of the gear 118, causing rotation of the rotating face and axle 119, causes the second slew drive mounting bracket 125, and therefore the remainder of the end effector 13, to move up and down. A stop 112 mounted on an inside face of the first slew drive mounting bracket 115 abuts tab 113 of the first flange 123 of the second slew drive mounting bracket 125 to prevent the end effector 13 from being raised past a certain point, and the stop 112 abuts tab 114 of the first flange 123 of the second slew drive mounting bracket 125 to prevent the end effector 13 from being lowered past a certain point.

The second slew drive 120 with the hydraulic motor 121 may be mounted in the second slew drive mounting bracket 125. The second slew drive 120 has a gear mounted to a rotating face and an axle as described in connection with the first slew drive 110. The rotating face and axle of the second slew drive 120 may be fixedly mounted on flanges 134, 137 of a third slew drive mounting bracket 135. The second slew drive 120 is mounted such that the face plane of the gear is oriented horizontally and longitudinally. Thus, rotation of the gear, and therefore rotation of the rotating plate and axle, causes the third slew drive mounting bracket 135, and therefore the remaining forward part of the end effector 13, to move right and left. A stop 122 mounted on the second slew drive 120 abuts the flange 134 at edge 136 to prevent the end effector 13 from moving left (as viewed from proximal end of the end effector) past a certain point. A stop 126 formed in the second slew drive mounting bracket 125 abuts the flange 134 at opposed edge 138 to prevent the end effector 13 from moving right past a certain point.

With reference especially to FIG. 7D, the third slew drive 130 with the hydraulic motor 131 may be fixedly mounted on the third slew drive mounting bracket 135. The third slew drive 130 is mounted such that the face plane of the gear is oriented vertically and transversely. The rotating plate 132 of the third slew drive 130 may be fixedly mounted by bolts 133 (only one labeled) to the mounting plate 129 mounted on the cylindrical body 210 of the multiport hydraulic swivel. Rotation of the gear, and therefore rotation of the rotating plate 132, causes the mounting plate 129 and the cylindrical body 210 to rotate about the longitudinal axis of the end effector 13, thereby causing rotation of the head 300 of the end effector 13.

With reference especially to FIG. 7E, a cross-sectional view of the first slew drive 110 illustrates how all of the slew drives may operate. The hydraulic motor 111 drives a threaded screw 117. The threads of the threaded screw 117 are meshed with teeth 116 of the gear 118 so that rotation of the threaded screw 117 in one direction about axis X-X causes rotation of the gear 118 in one direction about axis Y orthogonal to axis X-X. Reversing the direction of rotation of the threaded screw 117 reverses the direction of rotation of the gear 118. Rotation of the gear 118 causes rotation of the axle 119 on which the gear 118 is mounted as well as rotation of the rotating plate mounted on the gear 118. The gear ratio between the threaded screw 117 and the planetary gear 118 is high, which provides certain advantages. When hydraulic pressures at the hydraulic motors of these slew drives fail, the high gear ratios between the hydraulic motors and the screws provides positive control over the positions of the end effector at the end effector joints. Therefore, the slew drives are locked in place in the event of hydraulic failure, which prevents uncontrolled movement of the end effector thereby helping to prevent slippage of the object from the jaws of the jawed gripper. A high gear ratio between the threaded screw and the planetary gear may permit 360° rotation within a time of about 10 seconds, preferably within about 5 seconds.

With reference especially to FIG. 8A, FIG. 8B and FIG. 8C the head 300 may comprise a gripper (in this embodiment the jawed gripper 301) and a cutter (in this embodiment the chain saw 320). The jawed gripper 301 comprises opposed jaws 302, 303 between which an object, for example a tree branch, may be gripped. In some embodiments, the jaws may comprise shearing elements instead of or in addition to the chain saw, which can cut objects as the jaws are closed. This would be particularly useful for snipping smaller tree branches or finishing cutting a tree branch if the chain saw binds during operation.

The chain saw 320 may comprise the hydraulic motor 321, which receives hydraulic fluid through hydraulic lines from one or more of the ports 235 (e.g. two ports) on the swivel 200. The hydraulic motor 321 drives the cutting chain 323 of the chain saw 320 and may be switched on and off hydraulically. The dual acting hydraulic cylinder 322 pivotally mounted on the jawed gripper 301 proximate one end of the cylinder 322 and on the chain saw 320 proximate the other end of the cylinder 322 may be actuated by hydraulic fluid received from one or more of the ports 235 (e.g. two ports) on the swivel 200. The hydraulic cylinder 322 causes the cutting chain 323 to engage with or disengage from an object being gripped between the jaws 302, 303 of the jawed gripper 301. The chain saw 320 may be disposed next to the jawed gripper 301 so that the chain saw 320 cuts a tree branch between a trunk of the tree and the jawed gripper 301. In this way, the jawed gripper 301 will continue to hold the tree branch once the branch is separated from the tree. The tree branch may then be dropped by opening the jaws 302, 303 or lowered controllably to be placed in an appropriate location.

The opposed jaws 302, 303 of the jawed gripper 301 may be open and closed with a hydraulically-powered high gear ratio actuator, for example a high gear ratio screw drive 310 that operate similarly to the slew drives described above. The screw drive 310 may comprise a hydraulic motor that can drive a threaded screw 311 matingly engaged in a threaded aperture in a first jaw cross-piece 312 and in a threaded aperture in a second jaw cross-piece 313. The first jaw cross-piece 312 may extend between and be fixedly mounted on the two sides of jaw 302 and the second jaw cross-piece 313 may extend between and be fixedly mounted on the two sides of jaw 303. The threads in the threaded apertures in each jaw cross-piece 312, 313 may be oriented so that rotation of the screw 311 in one direction causes the opposed jaws 302, 303 to separate (open), while rotation of the screw 311 in the opposite direction causes the opposed jaws 302, 303 to come together (close). When hydraulic pressure at the hydraulic motor of the screw drive 310 fails, the high gear ratio between the hydraulic motor and the screw 311 provides positive control over the jaws 302, 303. Therefore, the jaws 302, 303 are locked in place in the event of hydraulic failure, which prevents uncontrolled opening of the jaws 302, 303 thereby helping to prevent slippage of the object from the jawed gripper 301. Further, the screw drive 310 may be very strong and may be over tightened to assist in maintaining the grip of the jawed gripper 301 even if the object being held slips after being cut. Furthermore, the jaws 302, 303 themselves provide considerable shearing and may be used to cut an object even in the absence or failure of the chain saw 320. To assist with such cutting by the jaws 302, 303, shearing elements 304, 305 may be secured to the jaws 302, 303, respectively, where the jaws 302, 303 contact the object as shown in FIG. 8A.

In FIG. 8A and FIG. 8B, the chain saw 320 is depicted in a non-cutting position because a blade 324 of the chain saw 320 is oriented toward the rear of the head 300. FIG. 8C illustrates the jawed gripper 301 with the opposed jaws 302, 303 in the closed position holding cut a branch 350 and the chain saw 320 in a position after having cut through the branch 350, with the chain saw blade 324 oriented toward the front of the head 300. The chain saw 320 may be moved into and through a cutting position as depicted in FIG. 8C using the dual acting hydraulic cylinder 322. Pressure from hydraulic fluid through hydraulic fluid ports 325, 326 of the hydraulic cylinder 322 may permit extension and retraction of cylinder rod 327. The cylinder rod 327 may be pivotally mounted on the chain saw 320, and cylinder body 328 may be pivotally mounted on the jawed gripper 301 or another fixed portion of the head 300. It is evident that the hydraulic cylinder 322 may be reversed so that the cylinder body 328 is pivotally mounted on the chain saw 320. Conveniently, a pivoting cross-member 329 mounted between opposed sides proximate a rear of jaw 302 may serve as a mounting point for the hydraulic cylinder 322 on the jawed gripper 301. Extension and retraction of the cylinder rod 327 may cause the chain saw 320 to pivot, and in the event of extension, the chain saw 320 pivots so that the blade 324 follows an arcuate path to engage whatever is being held in and is protruding from the jaws 302, 303. The gap between the chain saw blade 324 and the jaws 302, 303 is relatively small but sufficient to provide clearance for the cutting chain 323.

Further, as best seen in FIG. 8B, a camera 342 may be situated inside and at a rear of the jawed gripper 301 so that an operator can see exactly what is being gripped by the jawed gripper 301. In addition, as seen in FIG. 8B, a shaft encoder 345 may be situated to determine a position of the screw 311 at any given time in relation to one or both of the threaded apertures, and the position of the screw 311 may be used to determine a diameter of an object based on known geometry of the opposed jaws 302, 303. Given the diameter of the object, a length of the object as determined from images form one or more of the cameras 142, 342, and an estimated density of the object (e.g. whether the object is hardwood or softwood), a weight of the object may be determined. Additionally or alternatively, as seen in FIG. 8A, a strain gauge 346 may be used to determine weight of an object being held in the jawed gripper 301, but weight determined using the strain gauge 346 may be accurate only after the object (e.g. a branch) has been cut away from the object's source (e.g. a tree). In the context of tree pruning, collecting weight data may provide supervisors with information needed to determine the number of trucks that may be needed to chip all of the wood being cut.

A wireless transmitter 348 on the head 300 or on any other portion of the apparatus 1 may collect data from various sensors (e.g. shaft encoders, strain gauges, cameras, temperature gauges, wind speed gauges, timers, altimeters and the like) as well as information about equipment usage time, maintenance needs, etc. and transmit the data to a remote location. Integrating a global positioning system (GPS) with the wireless data transmission may provide location information related to the data being collected.

Furthermore, the apparatus may be provided with the controller 42 (as indicated in FIG. 1) comprising circuitry programmed with machine logic that may synthesize data elements related to object parameters, such as object weight, object diameter (e.g. as determined from width of jaw opening), object orientation in the gripper, object composition (e.g. hard wood, soft wood, thermoplastic polymer, thermoset polymer), etc., to determine whether the object is safe to cut. The machine logic may be programmed to prevent cutter operation in the event such parameters are outside predetermined limits. The circuitry may comprise a logic circuit, for example a programmable logic circuit (PLC), which may comprise one or more microprocessors.

The circuitry may also be programmed to operate any one or more other functions of the apparatus. For example, rotational speed of the slew drives 110, 120, 130 may be controlled to rotate the sections of the end effector slowly, proportionately and/or incrementally. A safety measure may be programmed to prevent opening of the gripper while the end effector is in motion. The circuit may be programmed to include a supervisory circuit that monitors one or more parameters of the apparatus, such as power supplies and microprocessors, to maintain the one or more parameters within certain limits and take appropriate action if a parameter goes out of bounds, creating an unacceptable or dangerous situation. The circuit may be programmed to provide reports of operating conditions, activity logs of the apparatus or any other feature of the apparatus. The circuitry may be programmed to communicate with and be operable from a remote location via electronic signals transmitted to and from a remote workstation over a network, e.g. the world wide web. As part of the programming,

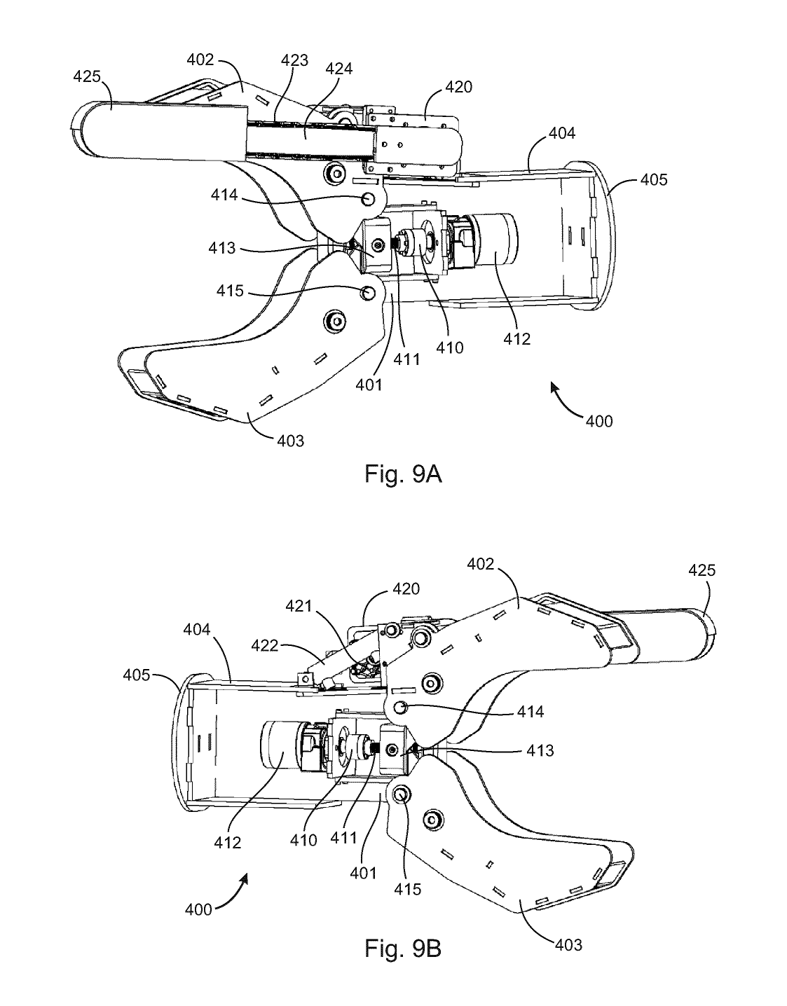

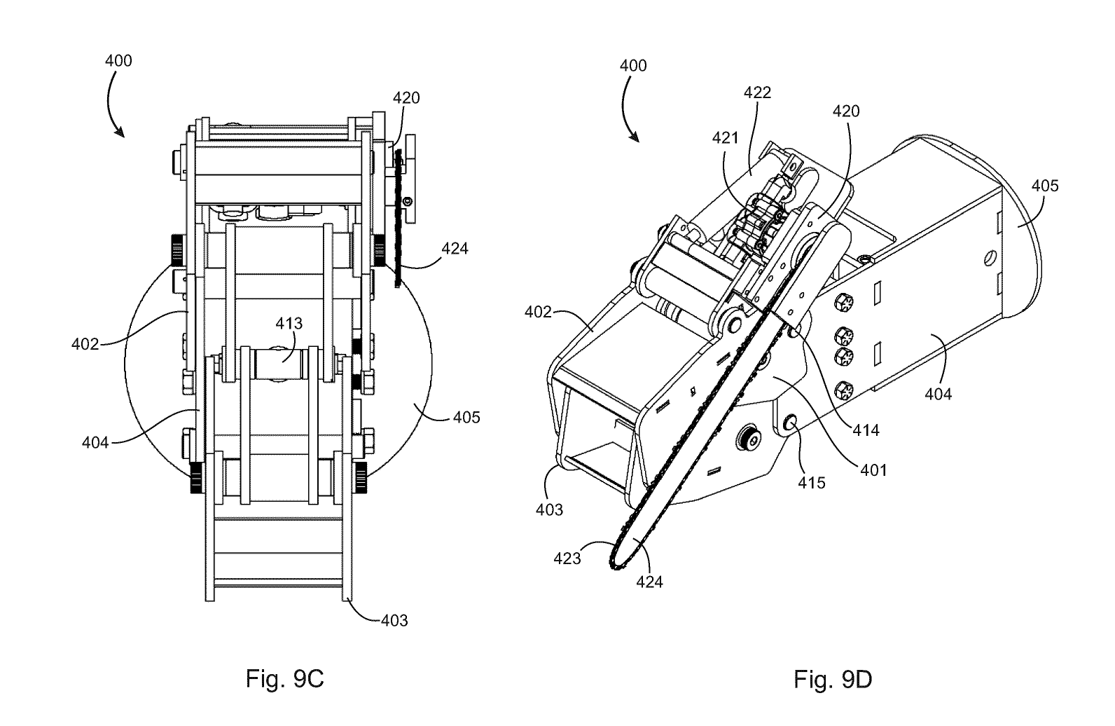

With reference to FIG. 9A, FIG. 9B, FIG. 9C and FIG. 9D, an alternative embodiment of a head 400 may comprise a chain saw 420 and a jawed gripper 401 having opposed jaws 402, 403. The chain saw 420 may comprise a hydraulic motor 421, which receives hydraulic fluid through hydraulic lines from a swivel (not shown). The hydraulic motor 421 drives a cutting chain 423 on a blade 424 of the chain saw 420 and may be switched on and off hydraulically. A dual acting hydraulic cylinder 422 pivotally mounted on the jawed gripper 401 proximate one end of the cylinder 422 and on the chain saw 420 proximate the other end of the cylinder 422 may be actuated by hydraulic fluid received from the swivel (not shown). The hydraulic cylinder 422 causes the cutting chain 423 to engage with or disengage from an object being gripped between the jaws 402, 403 of the jawed gripper 401. The chain saw 420 may be disposed next to the jawed gripper 401 so that the chain saw 420 cuts a tree branch between a trunk of the tree and the jawed gripper 401. In this way, the jawed gripper 401 will continue to hold the tree branch once the branch is separated from the tree. The tree branch may then be dropped by opening the jaws 402, 403 or lowered controllably to be placed in an appropriate location. A chain guard 425 may cover the blade 424 and the cutting chain 423 when the chain saw 420 is not in use. The head 400 may further comprise a mounting plate 405 through which the head 400 may be fixedly mounted to the swivel, for example by bolts.

In contrast to the head 300 depicted in FIG. 8A, the head 400 depicted in FIG. 9A, FIG. 9B, FIG. 9C and FIG. 9D has the chain saw 420 mounted to a rear of the jaws 402, 403. Thus, the blade 424 is pointing forward rather than backward in relation to the orientation of the head 400, and the chain saw 420 cuts down from above rather than up from below the object being cut. In this way, the hydraulic motor 421 of the chain saw 420 is to the rear of the head 400 and the hydraulic lines connected to the hydraulic motor 421 and hydraulic cylinder 422 are further away from the object being cut. Therefore, the hydraulic lines are less likely to become entangled on the object or other objects surrounding the object being cut (e.g. tree branches).

The opposed jaws 402, 403 of the jawed gripper 401 may be open and closed with a hydraulically-powered high gear ratio actuator, for example a high gear ratio screw drive 410. The screw drive 410 may comprise a hydraulic motor 412 that can drive a drive screw 411 engaged with the jaws 402, 403 to effect opening and closing of the jaws 402, 403. The drive screw 411 may be threadingly engaged with a screw block 413 so that rotation of the drive screw 411 in one direction causes the screw block 413 to translate longitudinally forward, while rotation of the drive screw 411 in the opposite direction causes the screw block 413 to translate longitudinally rearward. The screw block 413 may be pivotally connected to the jaws 402, 403 at pivot pins 414, 415, respectively, such that forward translation of the screw block 413 causes the jaws 402, 403 to open, while rearward translation of the screw block 413 causes the jaws 402, 403 to close. In this embodiment, the screw drive 410 and hydraulic motor 412 are located further to the rear of the jaws 402, 403 inside a body 404 of the jawed gripper 401 with the drive screw 411 parallel to a front-rear axis of the head 400 rather than perpendicular as depicted in the embodiment shown in FIG. 8A, FIG. 8B and FIG. 8C. In this way, the object gripped in the jawed gripper 401 is less likely to interfere with operation of the screw drive 410.

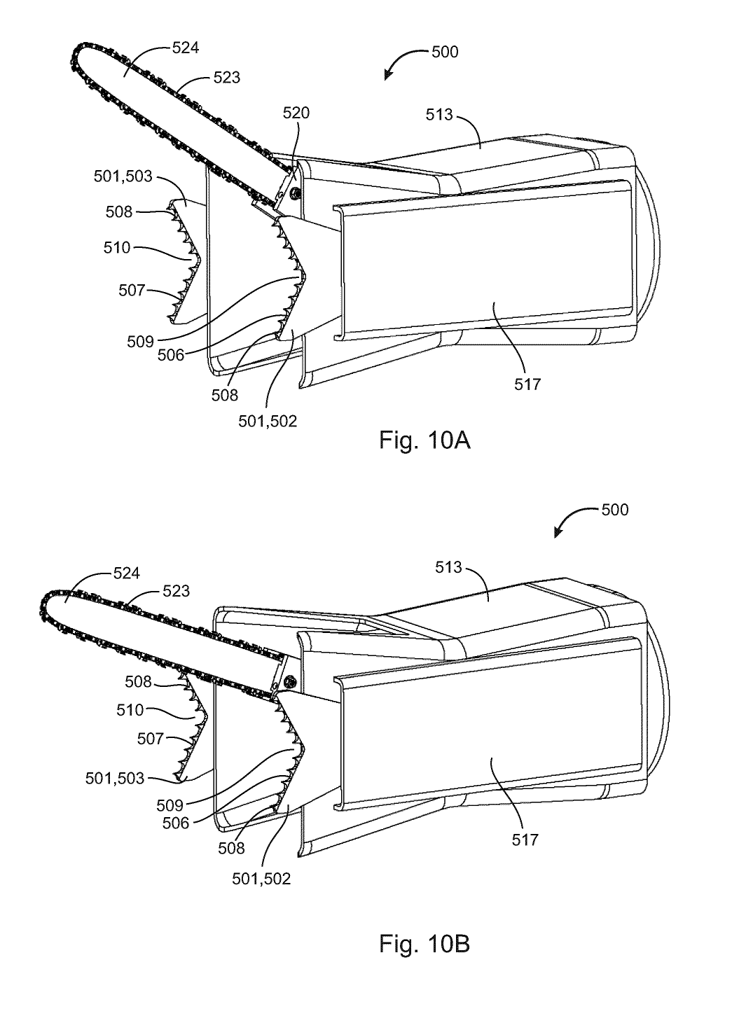

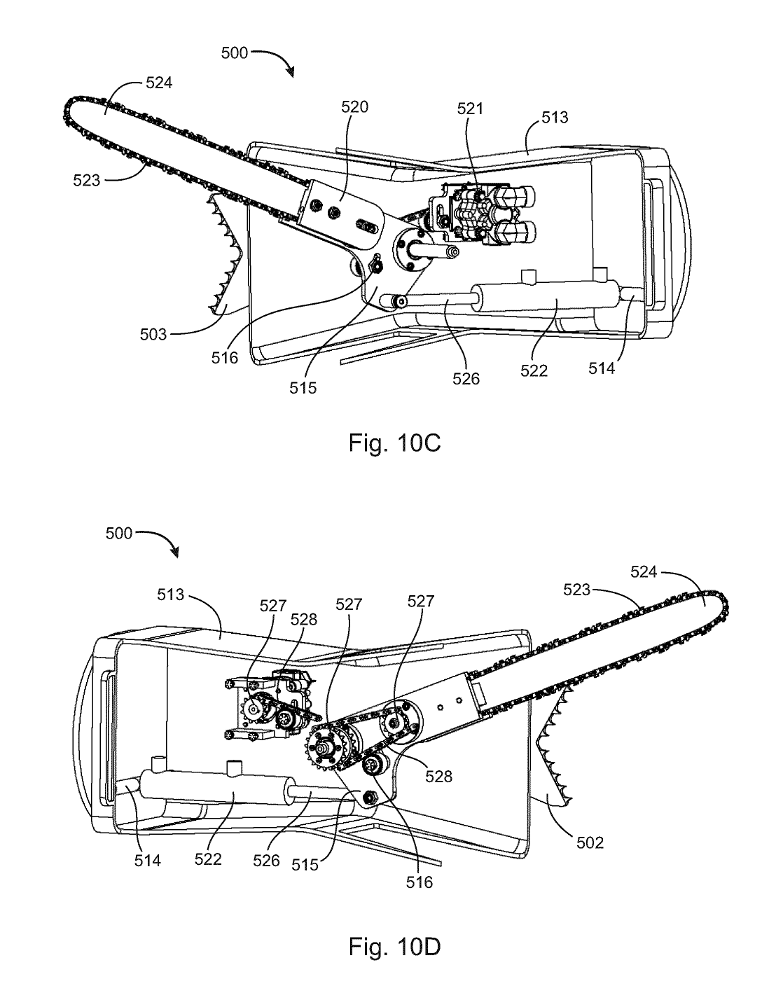

With reference to FIG. 10A, FIG. 10B, FIG. 10C and FIG. 10D, an alternative embodiment of a head 500 may comprise a chain saw 520 and a toothed immobilizer 501 having spaced apart substantially parallel toothed cheeks 502, 503. The toothed cheeks 502, 503 comprise anterior edges 506, 507, respectively, the anterior edges 506, 507 having edge portions that slope in a rearward direction to meet at apexes of V-shaped indentations 509, 510 in the cheeks 502, 503, respectively. The anterior edges 506, 507 each further comprise a plurality of forwardly protruding teeth 508 (only two labeled, one on each cheek) that are configured to immobilize an object situated within the indentations 509, 510. The anterior edges 506, 507 of the cheeks 502, 503 do not close around the object but immobilize the object by virtue of contact between the object and the protruding teeth 508. The object immobilized on the teeth 508 in the indentations 509, 510 is positioned to be cut by a cutting chain 523 on a blade 524 of the chain saw 520. Dual acting hydraulic cylinders (not shown) operatively connected to each cheek 502, 503 permit sliding the cheeks 502, 503 independently or in concert, forward or rearward in sheaths 517 (only one of two shown) to engage or disengage the protruding teeth 508 with the object.

With specific reference to FIG. 10C and FIG. 10D, the chain saw blade 524 may be moved from a more upwardly pointing non-cutting position (FIG. 10A) into a more downwardly pointing cutting position (FIG. 10B) by a dual acting hydraulic cylinder 522. The hydraulic cylinder 522 is pivotally mounted at a barrel end to a support brace 514 at a rear of and in a housing 513 of the head 500, and pivotally mounted at a rod end to a pivot plate 515 located forwardly in the housing 513. The pivot plate 515 is pivotally mounted to the housing 513 inside the housing 513 at a pivot point 516. The chain saw blade 524 is fixedly mounted on the pivot plate 515 so that pivoting of the pivot plate 515 will cause the blade 524 to lower through an arc into the cutting position or raise through an arc into the non-cutting position. Extension of a rod 526 pushes on the pivot plate 515 causing the pivot plate 515 to rotate around the pivot point 516 to raise the blade 524 into the non-cutting position. Retraction of the rod 526 pulls on the pivot plate 515 causing the pivot plate 515 to rotate around the pivot point 516 to lower the blade 524 into the cutting position. The hydraulic cylinder 522 may be actuated by hydraulic fluid received from the swivel (not shown).

The chain saw 520 may comprise a hydraulic motor 521, which receives hydraulic fluid through hydraulic lines from a swivel (not shown). The hydraulic motor 521 drives the cutting chain 523 on the blade 524 of the chain saw 520 and may be switched on and off hydraulically. The hydraulic motor 521 may be operatively linked to the cutting chain 523 through a gear set 527 mounted in the housing 513, the gear set 527 linked by drive chains 528 (see FIG. 10D) to transfer power from the hydraulic motor 521 to the cutting chain 523.

The embodiment depicted in FIG. 10A, FIG. 10B, FIG. 10C and FIG. 10D is more compact with fewer moving parts, and therefore suffers from less interference from surrounding obstacles (e.g. tree branches). Further, most of the chain saw components (e.g. the hydraulic motor and the hydraulic cylinder) are housed within the head offering greater protection for the chain saw components.

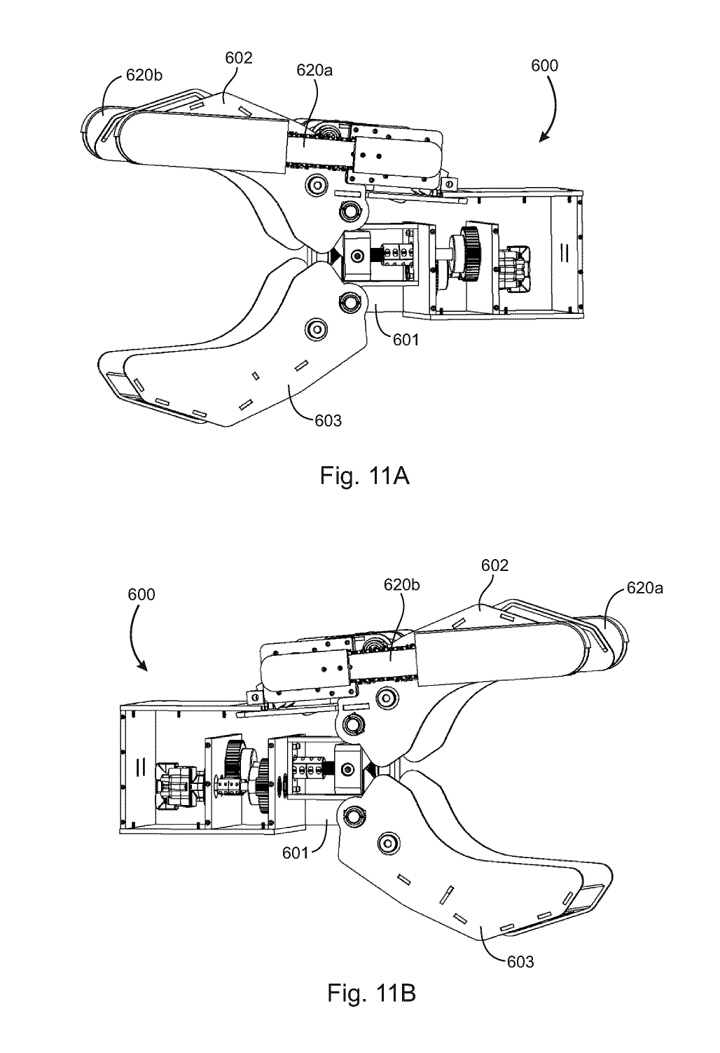

With reference to FIG. 11A and FIG. 11B, an alternative embodiment of a head 600 may comprise a jawed gripper 601 having opposed jaws 602, 603 and two chain saws 620a, 620b. The head 600 is the same as the head 400 depicted in FIG. 9A, FIG. 9B, FIG. 9C and FIG. 9D except for the presence of two chain saws instead of one. The head 600 may comprise an additional hydraulic cylinder (not shown) to operate the additional chain saw, otherwise the construction and operation of the head 600 is the same as the construction and operation of the head 400 described above.

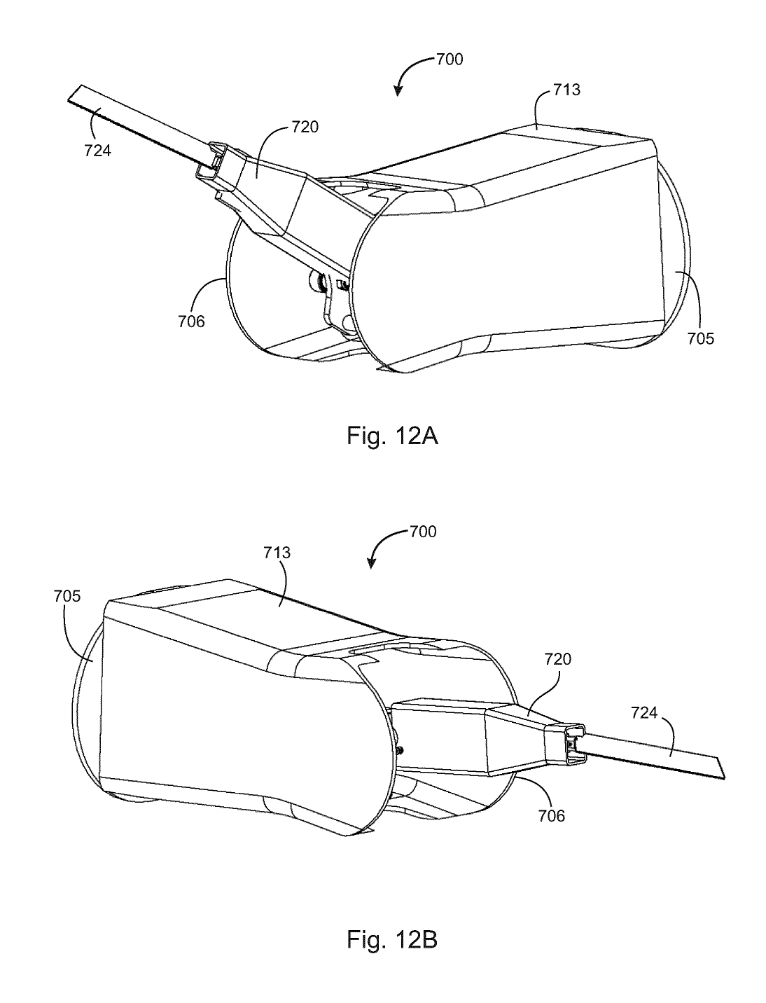

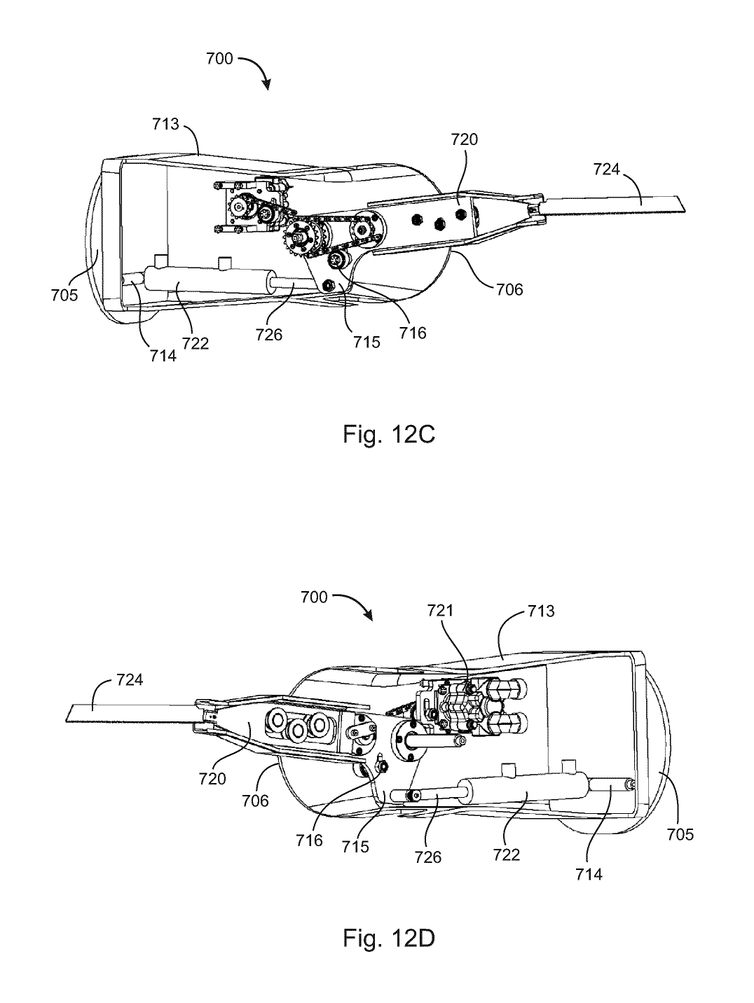

With reference to FIG. 12A, FIG. 12B, FIG. 12C and FIG. 12D, an alternative embodiment of a head 700, particularly useful for making collar cuts on trees, may comprise a reciprocating saw 720 and no immobilizer. The reciprocating saw 720 is driven by a hydraulic motor 721 situated toward a rear of the head 700 to avoid interference with a branch to be cut and surrounding foliage. The reciprocating saw comprises a blade 724 that extends beyond a forward-most portion 706 of a housing 713 of the head 700 such that the head 700 does not interfere with the blade 724 during the collar cut. A dual acting hydraulic cylinder 722 is pivotally mounted at a barrel end to a support brace 714 at a rear of and in the housing 713, and pivotally mounted at a rod end to a pivot plate 715 located forwardly in the housing 713. The pivot plate 715 is pivotally mounted to the housing 713 inside the housing 713 at a pivot point 716. The reciprocating saw 720 is fixedly mounted on the pivot plate 715 so that pivoting of the pivot plate 715 will cause the blade 724 to lower through an arc into the cutting position or raise through an arc into the non-cutting position. Extension of a rod 726 pushes on the pivot plate 715 causing the pivot plate 715 to rotate around the pivot point 716 to raise the blade 724 into the non-cutting position. Retraction of the rod 726 pulls on the pivot plate 715 causing the pivot plate 715 to rotate around the pivot point 716 to lower the blade 724 into the cutting position. The hydraulic cylinder 722 may be actuated by hydraulic fluid received from the swivel (not shown).

Operation of the reciprocating saw 720 by the hydraulic motor 721 is similar to the operation of the saw described in connection with the head shown in FIG. 10A, FIG. 10B, FIG. 10C and FIG. 10D. Also, the head 700 may be mounted on the swivel (not shown) through a mounting plate 705 at a rear of the head 700.

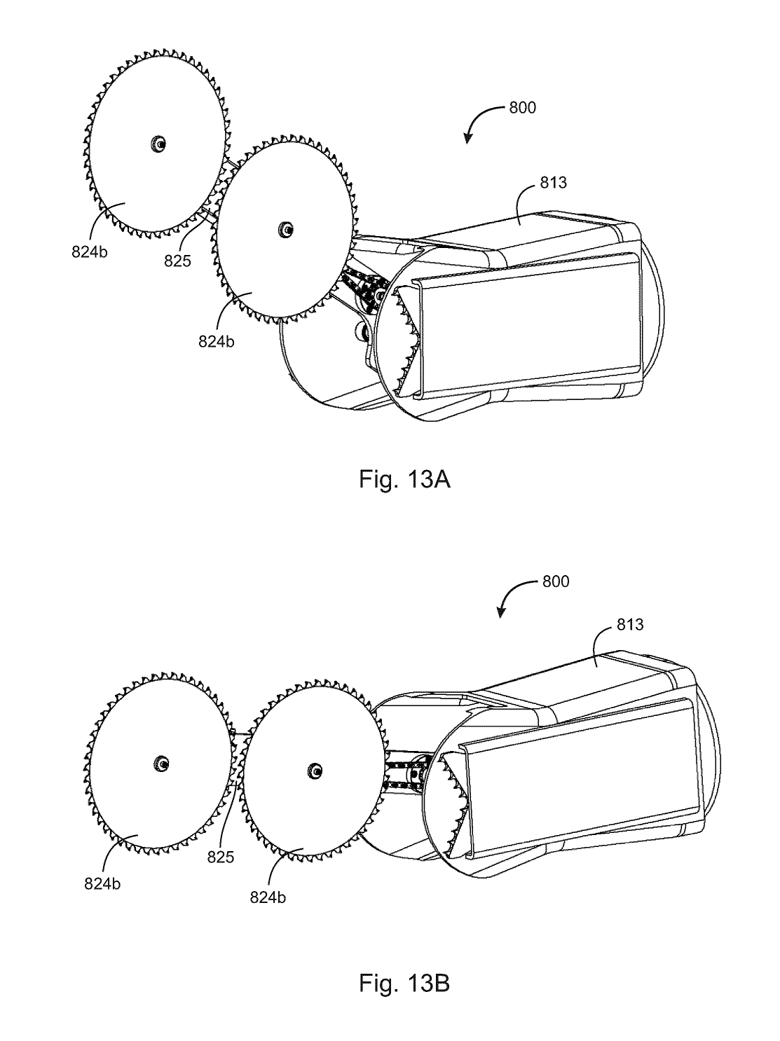

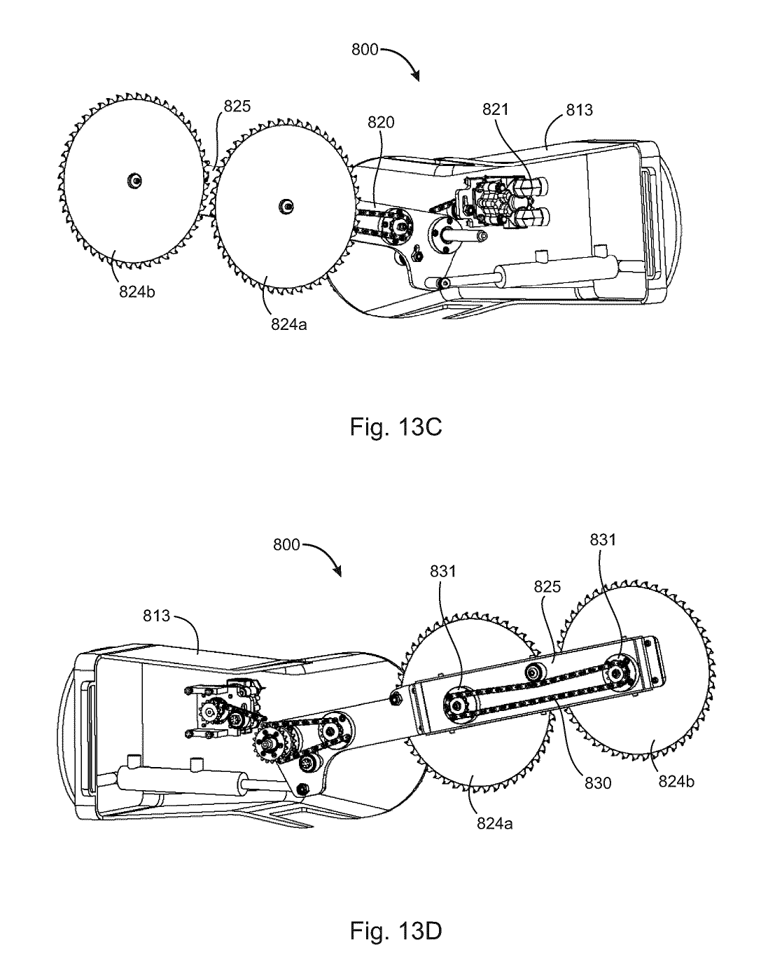

With reference to FIG. 13A, FIG. 13B, FIG. 13C and FIG. 13D, an alternative embodiment of a head 800, particularly useful for delimbing trees in a cut-and-drop operation, may comprise a saw 820 having first and second circular saw blades 824a, 824b, respectively. The two circular saw blades 824a, 824b may be rotationally mounted on a blade arm 825 extending forward of a housing 813 of the head 800. The first saw blade 824a closest to a hydraulic motor 821 is driven by the hydraulic motor 821 in a manner as described for the cutting chain 523 in connection with the head 500 shown in FIG. 10D. An endless chain 830 connecting gears 831 mounted on the two saw blades 824a, 824b permits the first saw blade 824a to drive the second saw blade 824b in tandem. Operation of the head 800 is otherwise similar to operation of the 700 described in connection with FIG. 12A, FIG. 12B, FIG. 12C and FIG. 12D.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. An apparatus for gripping and cutting, comprising:
a support configured to stably support the apparatus on a surface;
an articulated boom rotatably mounted on the support proximate a first end of the boom; and,
a hydraulically operated end effector mounted on the boom proximate a second end of the boom, the end effector comprising a gripper configured to hold an object to be cut and a cutter configured to cut the object while being held by the gripper, the end effector further comprising a swivel between the gripper and the boom, the swivel rotatable continuously through 360° to rotate the gripper continuously through 360°, the swivel comprising an internal fluid conduit through which hydraulic fluid may be transported from a hydraulic fluid reservoir to the gripper and cutter to hydraulically operate the gripper and cutter.

2. The apparatus according to claim 1, wherein the swivel comprises a rotatable core comprising the fluid conduit, a ring mounted on the core rotating with the core, and a non-rotatable housing disposed around the core, the fluid conduit in fluid communication with a first fluid port through the ring and a second fluid port through the housing, the fluid conduit transporting hydraulic fluid inside the swivel between the first and second fluid ports.

3. The apparatus according to claim 2, wherein the fluid conduit comprises a plurality of fluid conduits, the first fluid port comprises a first plurality of fluid ports, the second fluid port comprises a second plurality of fluid ports, and each of the plurality of fluid conduits fluidly connects one of the first fluid ports to one of the second fluid ports.

4. (canceled)

5. (canceled)

6. (canceled)

7. (canceled)

8. (canceled)

9. (canceled)

10. The apparatus according to claim 1, wherein the cutter comprises a chain saw, shearing elements that shear the object as the gripper grips the object or both a chain saw and shearing elements.

11. (canceled)

12. (canceled)

13. The apparatus according to claim 1, further comprising one or more cameras oriented to capture images of the gripper and/or cutter.

14. (canceled)

15. The apparatus according to claim 1, further comprising a data transmitter in electronic communication with one or more sensors on the apparatus, the data transmitter transmitting signals wirelessly to a remote data collection device.

16. (canceled)

17. The apparatus according to claim 15, wherein the one or more sensors comprises one or more of a global positioning system, a shaft encoder on an actuator, a timer, a strain gauge, a wind speed gauge, a temperature gauge, an altimeter and a camera.

18. The apparatus according to claim 1, further comprising one or more controllers, at least one controller comprising a logic circuit configured to automatically control one or more aspects of operation of the apparatus.

19. The apparatus according to claim 18, wherein the logic circuit is configured to synthesize data elements related to object parameters to determine whether cutting is safe.

20. The apparatus according to claim 18, wherein at least one of the one or more controllers comprises a remote control configured to permit an operator to control operation of the apparatus from a safe location away from the apparatus.

21. (canceled)

22. (canceled)

23. (canceled)

24. The apparatus according to claim 18, wherein the support comprises length-adjustable stabilizer legs configured to engage the surface to stably support the apparatus on the surface, and the logic circuit is configured to control length adjustment of the stabilizer legs.

25. An apparatus for cutting, comprising:
a support configured to stably support the apparatus on a surface;
an articulated boom rotatably mounted on the support proximate a first end of the boom; and,
a hydraulically operated end effector mounted on the boom proximate a second end of the boom, the end effector comprising a cutter configured to cut an object, the end effector further comprising a swivel between the cutter and the boom, the swivel rotatable continuously through 360° to rotate the cutter continuously through 360°, the swivel comprising an internal fluid conduit through which hydraulic fluid may be transported from a hydraulic fluid reservoir to the cutter to hydraulically operate the cutter.

26. The apparatus according to claim 25, wherein the end effector further comprises an immobilizer configured to immobilize an object to be cut.

27. (canceled)

28. The apparatus according to claim 26, wherein the immobilizer comprises a jawed gripper.

29. The apparatus according to claim 25, wherein the swivel comprises a rotatable core comprising the fluid conduit, a ring mounted on the core rotating with the core, and a non-rotatable housing disposed around the core, the fluid conduit in fluid communication with a first fluid port through the ring and a second fluid port through the housing, the fluid conduit transporting hydraulic fluid inside the swivel between the first and second fluid ports.

30. The apparatus according to claim 29, wherein the fluid conduit comprises a plurality of fluid conduits, the first fluid port comprises a first plurality of fluid ports, the second fluid port comprises a second plurality of fluid ports, and each of the plurality of fluid conduits fluidly connects one of the first fluid ports to one of the second fluid ports.

31. (canceled)

32. (canceled)

33. (canceled)

34. (canceled)

35. The apparatus according to claim 25, wherein the cutter comprises a chain saw, a reciprocal saw, a circular saw or any combination thereof.

36. (canceled)

37. (canceled)

38. The apparatus according to claim 25, further comprising one or more cameras oriented to capture images of the cutter.

39. (canceled)

40. The apparatus according to claim 25, further comprising a data transmitter in electronic communication with one or more sensors on the apparatus, the data transmitter transmitting signals wirelessly to a remote data collection device.

41. (canceled)

42. The apparatus according to claim 40, wherein the one or more sensors comprises one or more of a global positioning system, a shaft encoder on an actuator, a timer, a strain gauge, a wind speed gauge, a temperature gauge, an altimeter and a camera.

43. The apparatus according to claim 25, further comprising one or more controllers, at least one controller comprising a logic circuit configured to automatically control one or more aspects of operation of the apparatus.

44. The apparatus according to claim 43, wherein the logic circuit is configured to synthesize data elements related to object parameters to determine whether cutting is safe.

45. The apparatus according to claim 43, wherein at least one of the one or more controllers comprises a remote control configured to permit an operator to control operation of the apparatus from a safe location away from the apparatus.

46. (canceled)

47. (canceled)

48. (canceled)

49. The apparatus according to claim 43, wherein the support comprises length-adjustable stabilizer legs configured to engage the surface to stably support the apparatus on the surface, and the logic circuit is configured to control length adjustment of the stabilizer legs.
